(19) United States
(12) Patent Application Publication
(10) Pub. No.: US 2009/0170998 A1
(43) Pub. Date: Jul. 2, 2009

(54) SILICON CARBIDE CONTAINING THERMOPLASTIC COMPOSITIONS, METHOD OF PREPARING, AND ARTICLES COMPRISING THE SAME

(76) Inventors: Deval Gupta, Bangalore (IN); Raja Krishnamurthy, Bangalore (IN); Vitthal Abaso Sawant, District Sangli (IN); Rajashekhar Shiddappa Totad, Bangalore (IN); Sandeep Tyagi, Mumbai (IN)

Correspondence Address: CANTOR COLBURN LLP - SABIC (LEXAN/CYCOLOY), 20 Church Street, 22nd Floor, Hartford, CT, 06103, US

(21) Appl. No.: 11/965,952

(22) Filed: Dec. 28, 2007

(51) Int. Cl. C08K 3/34

(52) U.S. Cl. 524/443

(57) ABSTRACT

Disclosed herein is a thermoplastic composition comprising about 49.9 to about 99.9 parts by weight of a polycarbonate polymer, up to about 50 parts by weight of an impact modifier, and about 0.1 to about 30 parts by weight silicon carbide particles, wherein the amounts of the polycarbonate polymer, impact modifier, and silicon carbide are each based on 100 parts by weight of the polycarbonate, silicon carbide particles, and impact modifier, wherein the thermoplastic composition has a melt volume rate (MVR) of greater than or equal to 5 cc/10 min. when measured at a temperature of 300° C. under a load of 1.2 kg according to ISO 1133, and wherein an article molded from the thermoplastic composition has a notched Izod impact (NII) of greater than or equal to 4 kJ/m², when measured at a temperature of 23° C. and using a 2.7 J hammer, according to ISO 180. A method of making the composition, and articles formed therefrom, are also claimed.

### BACKGROUND OF THE INVENTION

The present invention relates to silicon carbide containing thermoplastic compositions, methods of preparing the silicon carbide thermoplastic compositions, and articles containing the silicon carbide thermoplastic compositions.

Thermoplastics have found widespread applications in different industries. Specifically, in automotive and telecom applications, thermoplastic compositions demand very high flow, stiff composites prepared from thermoplastics, along with significant ductility in the composites. Thin wall products that require extremely high flow to fabricate can be made using this technology. Desirable ductility properties include matrix yielding, elongation at break, and impact properties. Conventionally, materials have been made with incorporation of filler in plastics, which increases the modulus but leads to significant reduction in ductility (percent elongation at break).

However, there remains a need in the art for thermoplastics that can provide each of impact strength, modulus, and ductility while maintaining the desirable mold-filling characteristics based on melt flow properties.

### BRIEF DESCRIPTION OF THE INVENTION

The above-described and other drawbacks are alleviated by, in an embodiment, a thermoplastic composition comprising about 49.9 to about 99.9 parts by weight of a polycarbonate polymer, up to about 50 parts by weight of an impact modifier, and about 0.1 to about 30 parts by weight silicon carbide particles, wherein the amounts of the polycarbonate polymer, impact modifier, and silicon carbide are each based on 100 parts by weight of the polycarbonate, silicon carbide particles, and impact modifier, wherein the thermoplastic composition has a melt volume rate (MVR) of greater than or equal to 5 cc/10 min. when measured at a temperature of 300° C. under a load of 1.2 kg according to ISO 1133, and wherein an article molded from the thermoplastic composition has a notched Izod impact (NII) of greater than or equal to 4 kJ/m², when measured at a temperature of 23° C. and using a 2.7 J hammer, according to ISO 180.

In another embodiment, a thermoplastic composition comprises about 49.9 to about 94.9 parts by weight of a polycarbonate polymer having a melt volume rate (MVR) of 0.5 to 20 cc/10 min, measured at 300° C. under a load of 1.2 kg according to ISO 1133, about 0.1 to about 50 parts by weight of an impact modifier, and about 5 to about 15 parts by weight silicon carbide particles, wherein the amounts of the polycarbonate polymer, impact modifier, and silicon carbide are each based on 100 parts by weight of the polycarbonate, silicon carbide particles, and impact modifier, wherein an article molded from the thermoplastic composition has a notched Izod impact (NII) of greater than or equal to about 4 kJ/m², when measured at a temperature of 23° C. and using a 2.7 J hammer, according to ISO 180, and wherein an article molded from the thermoplastic composition has an unnotched Izod impact (UNI) of greater than or equal to about 80 kJ/m², when measured at a temperature of 23° C. and using a 2.7 J hammer, according to ISO 180.

In another embodiment, a method of forming a thermoplastic composition comprises melt blending about 49.9 to about 99.9 parts by weight of a polycarbonate polymer, up to about 50 parts by weight of an impact modifier, and about 0.1 to about 30 parts by weight silicon carbide particles, wherein the amounts of the polycarbonate polymer, impact modifier, and silicon carbide are each based on 100 parts by weight of the polycarbonate, silicon carbide particles, and impact modifier, wherein the thermoplastic composition has a melt volume rate (MVR) of greater than or equal to about 5 cc/10 min. when measured at a temperature of 300° C. under a load of 1.2 kg according to ISO 1133, wherein an article molded from the thermoplastic composition has a notched Izod impact (NII) of greater than or equal to about 4 kJ/m², when measured at a temperature of 23° C. and using a 2.7 J hammer, according to ISO 180.

A description of the figures, which are meant to be exemplary and not limiting, is provided below.

### BRIEF DESCRIPTION OF THE FIGURES

FIG. 1 is a plot of composite properties versus particle size for exemplary thermoplastic compositions.

FIG. 2 shows the individual plots of NII, tensile modulus, elongation at break, and yield stress versus average particle size for exemplary thermoplastic compositions.

FIG. 3 shows a plot of unnotched Izod (UNI) and dynatup impact versus particle size for exemplary thermoplastic compositions.

The above described and other features are exemplified by the following detailed description.

### DETAILED DESCRIPTION OF THE INVENTION

The present disclosure describes filled thermoplastic molding compositions for applications requiring high flow and high modulus, particularly at room temperature. Ductility at low temperatures (−30° C.) can also be achieved where filled, impact modified thermoplastic compositions are further used. Silicon carbide (SiC; either or both of micro and nano-sized particle sizes) filler is used to reinforce the polycarbonate matrix, providing a significant increase in the modulus at room temperature. Addition of SiC to high molecular weight PC also desirably results in a dramatic increase in melt volume rate (MVR), and no significant degradation of the polycarbonate (PC) was observed. Compositions with nano-SiC show excellent low temperature properties in tensile and impact tests. In addition, other thermoplastics can be included in the composition including acrylonitrile-butadiene-styrene terpolymers (ABS), other polycarbonate copolymers, polyesters, and the like. Additionally, the composition can provide improved hardness and abrasion resistance as conveyed by the corresponding properties of the silicon carbide. The concept can in principle be extended to other thermoplastic polymer compositions not herein disclosed to obtain an improvement in flow and tensile properties while maintaining the good balance between modulus and ductility at low temperatures.

The thermoplastic composition includes a polycarbonate. As used herein, the terms “polycarbonate” and “polycarbonate resin” mean compositions having repeating structural carbonate units of the formula (1):

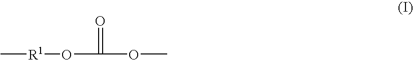

in which at least 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3):

HO-A¹-Y¹-A²-OH (3)

wherein Y¹, A¹ and A² are as described above. Also included are bisphenol compounds of general formula (4):

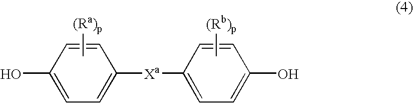

wherein R^{a} and R^{b} each represent a halogen atom or a monovalent hydrocarbon group and may be the same or different; p and q are each independently integers of 0 to 4; and X^{a} represents one of the groups of formula (5):

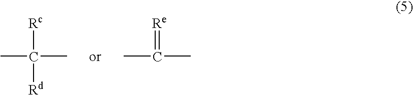

wherein R^{c} and R^{d} each independently represent a hydrogen atom or a monovalent linear or cyclic hydrocarbon group and R^{e} is a divalent hydrocarbon group.

In an embodiment, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)-, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group may have 3 to 20 atoms, and may be a single saturated or unsaturated ring, or fused polycyclic ring system wherein the fused rings are saturated, unsaturated, or aromatic.

Other bisphenols containing substituted or unsubstituted cyclohexane units can be used, for example bisphenols of formula (6):

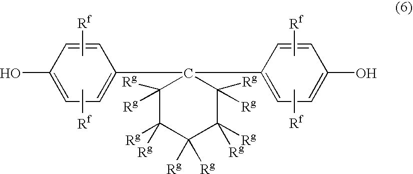

wherein each R^{f} is independently hydrogen, C₁₋₁₂ alkyl, or halogen; and each R^{g} is independently hydrogen or C₁₋₁₂ alkyl. The substituents may be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

Other useful dihydroxy compounds having the formula HO—R¹—OH include aromatic dihydroxy compounds of formula (7):

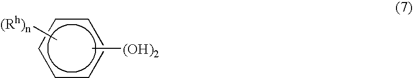

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

Exemplary dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like, as well as combinations comprising at least one of the foregoing dihydroxy compounds.

Specific examples of bisphenol compounds that may be represented by formula (3) include 1,1-bis(4-hydroxyphenyl)methane, 1,1-bis(4-hydroxyphenyl)ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds may also be used.

In a specific embodiment, the polycarbonate is a linear homopolymer derived from bisphenol A, in which each of A¹ and A² is p-phenylene and Y¹ is isopropylidene. The polycarbonates may have an intrinsic viscosity, as determined in chloroform at 25° C., of 0.3 to 1.5 deciliters per gram (dl/g), specifically 0.45 to 1.0 dl/g. The polycarbonates may have a weight average molecular weight (Mw) of 10,000 to 100,000, as measured by gel permeation chromatography (GPC) using a crosslinked styrene-divinyl benzene column, at a sample concentration of 1 milligram per milliliter, and as calibrated with polycarbonate standards.

In an embodiment, the polycarbonate has a melt volume flow rate (often abbreviated MVR) measures the rate of extrusion of a thermoplastics through an orifice at a prescribed temperature and load. Polycarbonates useful for the formation of articles may have an MVR, measured at 300° C. under a load of 1.2 kg according to ASTM D1238-04 or ISO 1133, of 0.5 to 80 cubic centimeters per 10 minutes (cc/10 min). In a specific embodiment, a useful polycarbonate or combination of polycarbonates (i.e., a polycarbonate composition) has an MVR measured at 300° C. under a load of 1.2 kg according to ASTM D1238-04 or ISO 1133, of 0.5 to 20 cc/10 min, specifically 0.5 to 18 cc/10 min, and more specifically 1 to 15 cc/10 min.

“Polycarbonates” and “polycarbonate resins” as used herein further include homopolycarbonates, copolymers comprising different R¹ moieties in the carbonate (referred to herein as “copolycarbonates”), copolymers comprising carbonate units and other types of polymer units, such as ester units, polysiloxane units, and combinations comprising at least one of homopolycarbonates and copolycarbonates. As used herein, “combination” is inclusive of blends, mixtures, alloys, reaction products, and the like. A specific type of copolymer is a polyester carbonate, also known as a polyester-polycarbonate. Such copolymers further contain, in addition to recurring carbonate chain units of the formula (1), repeating units of formula (8):

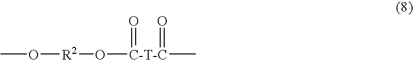

wherein R² is a divalent group derived from a dihydroxy compound, and may be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T divalent group derived from a dicarboxylic acid, and may be, for example, a C₂₋₁₀ alkylene group, a C₆₋₂₀ alicyclic group, a C₆₋₂₀ alkyl aromatic group, or a C₆₋₂₀ aromatic group.

In an embodiment, R² is a C₂₋₃₀ alkylene group having a straight chain, branched chain, or cyclic (including polycyclic) structure. In another embodiment, R² is derived from an aromatic dihydroxy compound of formula (4) above. In another embodiment, R² is derived from an aromatic dihydroxy compound of formula (7) above.

Examples of aromatic dicarboxylic acids that may be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is about 91:9 to about 2:98. In another specific embodiment, R² is a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers may vary broadly, for example 1:99 to 99:1, specifically 10:90 to 90:10, more specifically 25:75 to 75:25, depending on the desired properties of the final composition.

In a specific embodiment, the polyester unit of a polyester-polycarbonate may be derived from the reaction of a combination of isophthalic and terephthalic diacids (or derivatives thereof) with resorcinol. In another specific embodiment, the polyester unit of a polyester-polycarbonate is derived from the reaction of a combination of isophthalic acid and terephthalic acid with bisphenol-A. In a specific embodiment, the polycarbonate units are derived from bisphenol A. In another specific embodiment, the polycarbonate units are derived from resorcinol and bisphenol A in a molar ratio of resorcinol carbonate units to bisphenol A carbonate units of 1:99 to 99:1.

Polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. In an exemplary embodiment, an interfacial polymerization reaction to form carbonate linkages uses phosgene as a carbonate precursor, and is referred to as a phosgenation reaction.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1 to about 10 wt % based on the weight of bisphenol in the phosgenation mixture. In another embodiment an effective amount of phase transfer catalyst may be about 0.5 to about 2 wt % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 to about 2.0 wt %. Mixtures comprising linear polycarbonates and branched polycarbonates may be used.

A chain stopper (also referred to as a capping agent) may be included during polymerization. The chain-stopper limits molecular weight growth rate, and so controls molecular weight in the polycarbonate. Exemplary chain-stoppers include certain mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom may be specifically mentioned. Certain mono-phenolic UV absorbers may also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides may also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Alternatively, melt processes may be used to make the polycarbonates. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate, or a combination comprising at least one of the foregoing. In addition, transesterification catalysts for use may include phase transfer catalysts of formula (R³)₄Q⁺X above, wherein each R³, Q, and X are as defined above. Examples of transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

The polyester-polycarbonates may also be prepared by interfacial polymerization. Rather than utilizing the dicarboxylic acid per se, it is possible, and sometimes even preferred, to employ the reactive derivatives of the acid, such as the corresponding acid halides, in particular the acid dichlorides and the acid dibromides. Thus, for example instead of using isophthalic acid, terephthalic acid, or a combination comprising at least one of the foregoing, it is possible to employ isophthaloyl dichloride, terephthaloyl dichloride, and a combination comprising at least one of the foregoing.

In addition to the polycarbonates described above, combinations of the polycarbonate with other thermoplastic polymers, for example combinations of homopolycarbonates and/or polycarbonate copolymers with polyesters, may be used. Useful polyesters may include, for example, polyesters having repeating units of formula (8), which include poly(alkylene dicarboxylates), liquid crystalline polyesters, and polyester copolymers. The polyesters described herein are generally completely miscible with the polycarbonates when blended.

The polyesters may be obtained by interfacial polymerization or melt-process condensation as described above, by solution phase condensation, or by transesterification polymerization wherein, for example, a dialkyl ester such as dimethyl terephthalate may be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Useful polyesters may include aromatic polyesters, poly(alkylene esters) including poly(alkylene arylates), and poly(cycloalkylene diesters). Aromatic polyesters may have a polyester structure according to formula (8), wherein D and T are each aromatic groups as described hereinabove. In an embodiment, useful aromatic polyesters may include, for example, poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)] ester, or a combination comprising at least one of these. Also contemplated are aromatic polyesters with a minor amount, e.g., about 0.5 to about 10 wt %, based on the total weight of the polyester, of units derived from an aliphatic diacid and/or an aliphatic polyol to make copolyesters. Poly(alkylene arylates) may have a polyester structure according to formula (8), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters may also be used.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexane-dimethanol-1,4-cyclohexanedicarboxylate) (PCCD), having recurring units of formula (9):

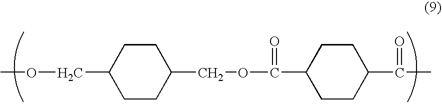

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

The polycarbonate and polyester and/or polyester-polycarbonate may be used in a weight ratio of 1:99 to 99:1, specifically 10:90 to 90:10, and more specifically 30:70 to 70:30, depending on the function and properties desired.

The polyester-polycarbonates may have a weight-averaged molecular weight (M_{w}) of 1,500 to 100,000, specifically 1,700 to 50,000, and more specifically 2,000 to 40,000. Molecular weight determinations are performed using gel permeation chromatography (GPC), using a crosslinked styrene-divinylbenzene column and calibrated to polycarbonate references. Samples are prepared at a concentration of about 1 mg/ml, and are eluted at a flow rate of about 1.0 ml/min.

Where used, it is desirable for a polyester-polycarbonate to have an MVR of about 5 to about 150 cc/10 min., specifically about 7 to about 125 cc/10 min, more specifically about 9 to about 110 cc/10 min, and still more specifically about 10 to about 100 cc/10 min., measured at 300° C. and a load of 1.2 kilograms according to ASTM D1238-04. Commercial polyester blends with polycarbonate are marketed under the trade name XYLEX®, including for example XYLEX® X7300, and commercial polyester-polycarbonates are marketed under the tradename LEXAN® SLX polymers, including for example LEXAN® SLX-9000, and are available from SABIC Innovative Plastics (formerly GE Plastics).

The thermoplastic composition may also comprise a polysiloxane-polycarbonate copolymer, also referred to as a polysiloxane-polycarbonate. The polysiloxane (also referred to herein as “polydiorganosiloxane”) blocks of the copolymer comprise repeating siloxane units (also referred to herein as “diorganosiloxane units”) of formula (10):

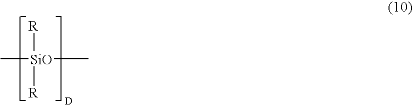

wherein each occurrence of R is same or different, and is a C₁₋₁₃ monovalent organic radical. For example, R may independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups may be fully or partially halogenated with fluorine, chlorine, bromine, or iodine, or a combination thereof. Combinations of the foregoing R groups may be used in the same copolymer.

The value of D in formula (10) may vary widely depending on the type and relative amount of each component in the thermoplastic composition, the desired properties of the composition, and like considerations. Generally, D may have an average value of 2 to 1,000, specifically 2 to 500, and more specifically 5 to 100. In one embodiment, D has an average value of 10 to 75, and in still another embodiment, D has an average value of 40 to 60. Where D is of a lower value, e.g., less than 40, it may be desirable to use a relatively larger amount of the polycarbonate-polysiloxane copolymer. Conversely, where D is of a higher value, e.g., greater than 40, it may be necessary to use a relatively lower amount of the polycarbonate-polysiloxane copolymer.

A combination of a first and a second (or more) polysiloxane-polycarbonate copolymer may be used, wherein the average value of D of the first copolymer is less than the average value of D of the second copolymer.

In one embodiment, the polydiorganosiloxane blocks are provided by repeating structural units of formula (11):

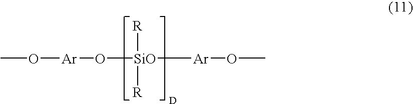

wherein D is as defined above; each R may independently be the same or different, and is as defined above; and each Ar may independently be the same or different, and is a substituted or unsubstituted C₆-C₃₀ arylene radical, wherein the bonds are directly connected to an aromatic moiety. Useful Ar groups in formula (11) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of dihydroxyarylene compounds are 1,1-bis(4-hydroxyphenyl)methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulphide), and 1,1-bis(4-hydroxy-t-butylphenyl) propane. Combinations comprising at least one of the foregoing dihydroxy compounds may also be used.

Units of formula (11) may be derived from the corresponding dihydroxy compound of formula (12):

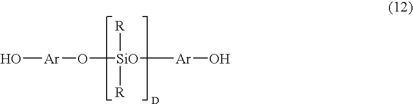

wherein R, Ar, and D are as described above. Compounds of formula (12) may be obtained by the reaction of a dihydroxyarylene compound with, for example, an alpha, omega-bisacetoxypolydiorangonosiloxane under phase transfer conditions.

In another embodiment, polydiorganosiloxane blocks comprise units of formula (13):

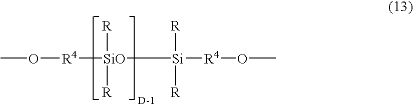

wherein R and D are as described above, and each occurrence of R⁴ is independently a divalent C₁-C₃₀ alkylene, and wherein the polymerized polysiloxane unit is the reaction residue of its corresponding dihydroxy compound. In a specific embodiment, the polydiorganosiloxane blocks are provided by repeating structural units of formula (14):

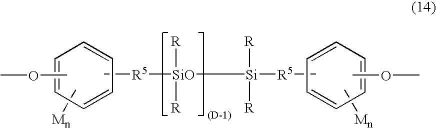

wherein R and D are as defined above. Each R⁵ in formula (14) is independently a divalent C₂-C₈ aliphatic group. Each M in formula (14) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R⁵ is a divalent C₁-C₃ aliphatic group, and R is methyl.

Units of formula (14) may be derived from the corresponding dihydroxy polydiorganosiloxane (15):

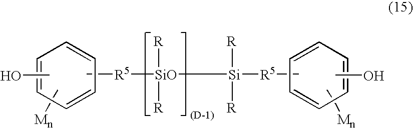

wherein R, D, M, R⁵, and n are as described above. Such dihydroxy polysiloxanes can be made by effecting a platinum catalyzed addition between a siloxane hydride of formula (16):

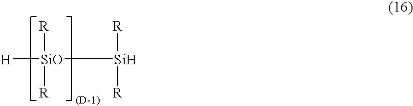

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The polysiloxane-polycarbonate may comprise 50 to 99 wt % of carbonate units and 1 to 50 wt % siloxane units. Within this range, the polysiloxane-polycarbonate copolymer may comprise 70 to 98 wt %, specifically 75 to 97 wt % of carbonate units and 2 to 30 wt %, specifically 3 to 25 wt % siloxane units.

In an embodiment, the polysiloxane-polycarbonate may comprise polysiloxane units, and carbonate units derived from bisphenol A, e.g., the dihydroxy compound of formula (3) in which each of A¹ and A² is p-phenylene and Y¹ is isopropylidene. Polysiloxane-polycarbonates may have a weight average molecular weight of 2,000 to 100,000, specifically 5,000 to 50,000 as measured by gel permeation chromatography using a crosslinked styrene-divinyl benzene column, at a sample concentration of 1 milligram per milliliter, and as calibrated with polycarbonate standards.

The polysiloxane-polycarbonate can have a melt volume flow rate, measured at 300° C. under a load of 1.2 kg, of 1 to 50 cubic centimeters per 10 minutes (cc/10 min), specifically 2 to 30 cc/10 min. Mixtures of polysiloxane-polycarbonates of different flow properties may be used to achieve the overall desired flow property. In an embodiment, exemplary polysiloxane-polycarbonates are marketed under the trade name LEXAN® EXL polycarbonates, available from SABIC Innovative Plastics (formerly GE Plastics).

The thermoplastic composition comprises a silicon carbide particle filler. Silicon carbide particles as disclosed herein can be used in any suitable form, including but not limited to microparticles, nanoparticles, and particles having various shapes including spheres, rods, faceted crystalline shapes, irregular shapes, and the like. The size of the silicon particles as measured by the longest dimension, also referred to as particle diameter, can be described more generally using the mean of the distribution of the particle diameters, also referred to as the mean particle diameter. As used herein, microparticles of SiC have a mean particle diameter (D₅₀), also referred to herein as an average particle size, of greater than about 0.2 to about 1,000 micrometers, specifically about 1 to about 500 micrometers, and more specifically about 2 to about 200 micrometers. In exemplary embodiments, useful SiC microparticles have an average particle size of about 5 to about 150 micrometers. The average maximum particle size for SiC microparticles varies with the average particle size, and can in general be about 1 to about 1,000 micrometers, specifically about 5 to about 500 micrometers. Also as used herein, nanoparticles of SiC have an average largest dimension (D₅₀) of about 1 to about 200 nanometers, specifically about 2 to about 150 nanometers, more specifically about 2 to about 100 nanometers, and still more specifically about 2 to about 50 nanometers. In exemplary embodiments, the SiC nanoparticles can have an average particle size of about 3 to about 30 nanometers (nm). The distribution of average particle sizes can be unimodal, bimodal, or multimodal. The average maximum particle size for SiC nanoparticles varies with the average particle size, and can be about 2 to about 500 nanometers, and specifically about 5 to about 200 micrometers. In an embodiment, the total amount by weight of the SiC micro- or nanoparticles that are of the average maximum particle size or higher is <3%. Particle sizes can be determined using various methods, typically light scattering methods including static light scattering (SLS) and dynamic light scattering (DLS), also referred to generally as laser light scattering techniques.

Surface area can also be considered as a relevant factor in determining desirable characteristics of the SiC particles. For example, SiC microparticles can further have a specific surface area of about 1 to about 20 m²/g, and nanoparticles can further have a specific surface area of about 10 to about 75 m²/g.

Silicon carbide particles can be used in varying stages of compositional purity. Where desired, silicon carbide can have minor amounts of impurities of less than or equal to about 1% by weight, specifically less than about 0.5% by weight, more specifically less than or equal to about 0.1% by weight, still more specifically less than or equal to about 0.01% by weight, and still more specifically less than or equal to about 0.001% by weight, based on the total weight of the SiC particles. In one embodiment, the silicon carbide can contain minor amounts of impurities such as silicon, silica, iron, calcium, magnesium, aluminum, and combinations of these, without deleterious effects on the thermoplastic composition. In another embodiment, the silicon carbide can comprise different morphological forms of silicon carbide including alpha, beta, and amorphous silicon carbides, or mixtures of these. The silicon carbide particles disclosed herein do not require separation or purification of phases to provide a suitable material. In an embodiment, the silicon carbide contains minor amounts of amorphous silicon carbide as defined hereinabove, without deleterious effect.

The silicon carbides as used can be untreated, or used as treated, coated, and/or dispersed forms. Any suitable surface coating agent, treatment, or dispersant can be used that is suitable to adjust as desired the dispersing properties, adhesion properties, or other such properties of the silicon carbide micro- or nanoparticles used herein. In an exemplary embodiment, the silicon carbide can be treated with an epoxy resin, organosilane, or other compound. In addition, it is contemplated that the silicon carbide can be in a single structured particle, or as a core-shell structured particle, with the core and shell layers having different phases of SiC. Any such structure is contemplated, provided the inclusion of the structured particle does not have any significantly adverse effects on the properties of the thermoplastic composition.

Silicon carbide particles provided in finely-divided form may be produced by stepwise growth using vapor precursors and sintering, or more typically by grinding, ball milling or jet milling larger particles of silicon carbide and subsequently classifying or separating according to size component criteria. Silicon carbide nanoparticles that are useful herein can be obtained commercially from manufacturers such as Saint Gobain.

In an embodiment, the thermoplastic composition comprises silicon carbide particles in an amount of about 0.1 to about 30 parts by weight, specifically about 1 to about 25 parts by weight, and more specifically about 2 to about 20 parts by weight, based on 100 parts by weight of polycarbonate, silicon carbide particles, and any impact modifier. In an embodiment, where an impact modifier is included, the silicon carbide can be used in an amount of about 5 to about 15 parts by weight, based on 100 parts by weight of polycarbonate, silicon carbide particles, and impact modifier.

The thermoplastic composition can further include impact modifier(s). These impact modifiers include elastomer-modified graft copolymers comprising (i) an elastomeric (i.e., rubbery) polymer substrate having a glass transition temperature (T_{g}) less than or equal to about 10° C., more specifically less than or equal to about −10° C., or more specifically about −40° C. to about −80° C., and (ii) a rigid polymeric substrate grafted to the elastomeric polymer substrate. As is known, elastomer-modified graft copolymers can be prepared by first providing the elastomeric polymer, then polymerizing the constituent monomer(s) of the rigid phase in the presence of the elastomer to obtain the graft copolymer. The grafts can be attached as graft branches or as shells to an elastomer core. The shell can merely physically encapsulate the core, or the shell can be partially or essentially completely grafted to the core.

Materials for use as the elastomer phase include, for example, conjugated diene rubbers; copolymers of a conjugated diene with less than or equal to about 50 weight percent of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers.

Conjugated diene monomers for preparing the elastomer phase include those of formula (17):

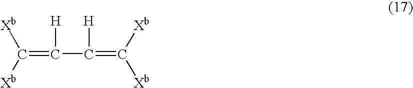

wherein each X^{b} is independently hydrogen, C₁-C₅ alkyl, or the like. Examples of conjugated diene monomers that can be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as combinations comprising at least one of the foregoing conjugated diene monomers. Specific conjugated diene homopolymers include polybutadiene and polyisoprene.

Copolymers of a conjugated diene rubber can also be used, for example those produced by aqueous radical emulsion polymerization of a conjugated diene and at least one monomer copolymerizable therewith. Monomers that are useful for copolymerization with the conjugated diene include monovinylaromatic monomers containing condensed aromatic ring structures, such as vinyl naphthalene, vinyl anthracene, and the like, or monomers of formula (18):

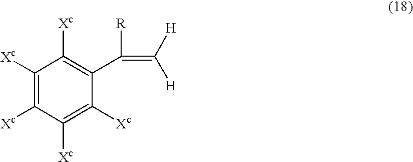

wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkylaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Exemplary monovinylaromatic monomers that can be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene can be used as monomers copolymerizable with the conjugated diene monomer.

Other monomers that can be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (19):

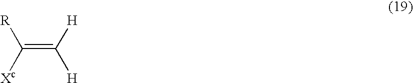

wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, or the like. Examples of monomers of formula (19) include acrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Combinations of the foregoing monovinyl monomers and monovinylaromatic monomers can also be used.

(Meth)acrylate monomers for use in the elastomeric phase can be cross-linked, particulate emulsion homopolymers or copolymers of C₁₋₈ alkyl (meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₈ alkyl (meth)acrylate monomers can optionally be polymerized in admixture with less than or equal to about 15 weight percent of comonomers of formulas (17), (18), or (19), based on the total monomer weight. Exemplary comonomers include but are not limited to butadiene, isoprene, styrene, methyl methacrylate, phenyl methacrylate, phenethylmethacrylate, N-cyclohexylacrylamide, vinyl methyl ether or acrylonitrile, and combinations comprising at least one of the foregoing comonomers. Optionally, less than or equal to about 5 weight percent of a polyfunctional crosslinking comonomer can be present, based on the total monomer weight. Such polyfunctional crosslinking comonomers can include, for example, divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase can be polymerized by mass, emulsion, suspension, solution or combined processes such as bulk-suspension, emulsion-bulk, bulk-solution or other techniques, using continuous, semi-batch, or batch processes. The particle size of the elastomer substrate is not critical. For example, an average particle size of about 0.001 to about 25 micrometers, specifically about 0.01 to about 15 micrometers, or even more specifically about 0.1 to about 8 micrometers can be used for emulsion based polymerized rubber lattices. A particle size of about 0.5 to about 10 micrometers, specifically about 0.6 to about 1.5 micrometers can be used for bulk polymerized rubber substrates. Particle size can be measured by simple light transmission methods or capillary hydrodynamic chromatography (CHDF). The elastomer phase can be a particulate, moderately cross-linked conjugated butadiene or C₄₋₆ alkyl acrylate rubber, and specifically has a gel content greater than 70%. Also useful are combinations of butadiene with styrene and/or C₄₋₆ alkyl acrylate rubbers.

The elastomeric phase comprises about 5 to about 95 weight percent of the total graft copolymer, more specifically about 20 to about 90 weight percent, and even more specifically about 40 to about 85 weight percent of the elastomer-modified graft copolymer, the remainder being the rigid graft phase.

The rigid phase of the elastomer-modified graft copolymer can be formed by graft polymerization of a combination comprising a monovinylaromatic monomer and optionally at least one comonomer in the presence of at least one elastomeric polymer substrates. The above-described monovinylaromatic monomers of formula (18) can be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or combinations comprising at least one of the foregoing monovinylaromatic monomers. Useful comonomers include, for example, the above-described monovinylic monomers and/or monomers of the general formula (17). In one embodiment, R is hydrogen or C₁-C₂ alkyl, and X^{c} is cyano or C₁-C₁₂ alkoxycarbonyl. Exemplary comonomers for use in the rigid phase include acrylonitrile, methacrylonitrile, methyl (meth)acrylate, ethyl (meth)acrylate, n-propyl (meth)acrylate, isopropyl (meth)acrylate, and the like, and combinations comprising at least one of the foregoing comonomers.

The relative ratio of monovinylaromatic monomer and comonomer in the rigid graft phase can vary widely depending on the type of elastomer substrate, type of monovinylaromatic monomer(s), type of comonomer(s), and the desired properties of the impact modifier. The rigid phase can generally comprise less than or equal to about 100 weight percent of monovinyl aromatic monomer, specifically about 30 to about 100 weight percent, more specifically about 50 to about 90 weight percent monovinylaromatic monomer, with the balance of the rigid phase being comonomer(s).

Depending on the amount of elastomer-modified polymer present, a separate matrix or continuous phase of ungrafted rigid polymer or copolymer can be simultaneously obtained along with the elastomer-modified graft copolymer. Such impact modifiers can comprise about 40 to about 95 weight percent elastomer-modified graft copolymer and about 5 to about 65 weight percent graft copolymer, based on the total weight of the impact modifier. In another embodiment, such impact modifiers comprise about 50 to about 85 weight percent, more specifically about 75 to about 85 weight percent rubber-modified graft copolymer, together with about 15 to about 50 weight percent, more specifically about 15 to about 25 weight percent graft copolymer, based on the total weight of the impact modifier.

Another specific type of elastomer-modified impact modifier comprises structural units derived from at least one silicone rubber monomer, a branched acrylate rubber monomer having the formula H₂C═C(R^{d})C(O)OCH₂CH₂R^{e}, wherein R^{d} is hydrogen or a C₁-C₈ linear or branched alkyl group and R^{e} is a branched C₃-C₁₆ alkyl group; a first graft link monomer; a polymerizable alkenyl-containing organic material; and a second graft link monomer. The silicone rubber monomer can comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, e.g., decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane, octamethylcyclotetrasiloxane and/or tetraethoxysilane.

Exemplary branched acrylate rubber monomers include iso-octyl acrylate, 6-methyloctyl acrylate, 7-methyloctyl acrylate, 6-methylheptyl acrylate, and the like, or a combination comprising at least one of the foregoing. The polymerizable alkenyl-containing organic material can be, for example, a monomer of formula (18) or (19), e.g., styrene, alpha-methylstyrene, acrylonitrile, methacrylonitrile, or an unbranched (meth)acrylate such as methyl methacrylate, 2-ethylhexyl methacrylate, methyl acrylate, ethyl acrylate, n-propyl acrylate, or the like, alone or in combination.

The first graft link monomer can be an (acryloxy)alkoxysilane, a (mercaptoalkyl)alkoxysilane, a vinylalkoxysilane, or an allylalkoxysilane, alone or in combination, e.g., (gamma-methacryloxypropyl)(dimethoxy)methylsilane and/or (3-mercaptopropyl)trimethoxysilane. The second graft link monomer is a polyethylenically unsaturated compound having at least one allyl group, such as allyl methacrylate, triallyl cyanurate, triallyl isocyanurate, and the like, or a combination comprising at least one of the foregoing.

The silicone-acrylate impact modifiers can be prepared by emulsion polymerization, wherein, for example a silicone rubber monomer is reacted with a first graft link monomer at a temperature from about 30° C. to about 110° C. to form a silicone rubber latex, in the presence of a surfactant such as dodecylbenzenesulfonic acid. Alternatively, a cyclic siloxane such as cyclooctamethyltetrasiloxane and a tetraethoxyorthosilicate can be reacted with a first graft link monomer such as (gamma-methacryloxypropyl)methyldimethoxysilane). A branched acrylate rubber monomer is then polymerized with the silicone rubber particles, optionally in presence of a cross linking monomer, such as allyl methacrylate, in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid can be separated from the aqueous phase through coagulation (by treatment with a coagulant) and dried to a fine powder to produce the silicone-acrylate rubber impact modifier. This method can be generally used for producing the silicone-acrylate impact modifier having a particle size of about 100 nanometers to about 2 micrometers.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semi-batch, or batch processes.

If desired, the foregoing types of impact modifiers are prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization, and can catalyze transesterification and/or degradation of polycarbonates. Instead, ionic sulfate, sulfonate or phosphate surfactants can be used in preparing the impact modifiers, particularly the elastomeric substrate portion of the impact modifiers. Useful surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, or a combination comprising at least one of the foregoing. A specific surfactant is a C₆₋₁₆, specifically a C₈₋₁₂ alkyl sulfonate. This emulsion polymerization process is described and disclosed in various patents and literature of such companies as Rohm & Haas and General Electric Company. In the practice, any of the above-described impact modifiers can be used providing it is free of the alkali metal salts of fatty acids, alkali metal carbonates and other basic materials.

A specific impact modifier of this type is a methyl methacrylate-butadiene-styrene (MBS) impact modifier wherein the butadiene substrate is prepared using above-described sulfonates, sulfates, or phosphates as surfactants. Other examples of elastomer-modified graft copolymers in addition to ABS and MBS include but are not limited to acrylonitrile-styrene-butyl acrylate (ASA), methyl methacrylate-acrylonitrile-butadiene-styrene (MABS), and acrylonitrile-ethylene-propylene-diene-styrene (AES). In an embodiment, impact modifiers as used herein can include either or both of a non-elastomer-modified copolymer or an elastomer-modified copolymer. In an exemplary embodiment, a non-elastomer-modified copolymer is styrene-acrylonitrile (SAN).

Where used, the thermoplastic composition can comprise impact modifier in an amount of up to about 50 parts by weight, specifically about 0.1 to about 50 parts by weight, more specifically about 1 to about 40 parts by weight, and more specifically about 2 to about 30 parts by weight, based on 100 parts by weight of polycarbonate, silicon carbide particles, and the impact modifier.

It has been found that to obtain high flow compositions, mixtures of low:high flow PC can be used, and for additional improvement in flow, a styrene-acrylonitrile copolymer (SAN) can be added. This reduces long times otherwise experienced in the flow and mold-filling properties of the compositions. Further, to improve the mechanical properties, glass and carbon fiber, mineral fillers, particulate fillers and nano fillers have also been included; however, the failure mode for such compositions is brittle, and the resulting compositions can also have very low impact strength. In addition, inclusion of filler can also lead to reduction in flow. Some fillers, depending on their surface characteristics, can also cause mild to severe degradation of polycarbonate, which renders the overall composition of marginal use for practical applications. Fiber-reinforced composites give good mechanical properties but have found limited use in injection molding applications for thin wall thickness due to the accompanying lower flow, and the surface aesthetics of glass and carbon fiber reinforced composites is generally poor. Nano fillers like nanoclays and nanoparticles give a good balance of modulus and ductility but are unable to provide the magnitude of stiffness required. High purity talc has been included to improve the mechanical properties and retention of desirable time dependent properties of PC and blends thereof, but the use of mineral fillers such as talc, wollastonite, kaolin, mica, novacumite, and the like, results in a level of stiffness or modulus increment that is typically too low to maintain the necessary ductility. Rubbers can be added to enhance the low temperature properties of the thermoplastics, but this can result in a significant decrease of the modulus.

Surprisingly, it has been found that inclusion of silicon carbide micro or nanoparticles in a thermoplastic composition comprising a polycarbonate has dramatically improved melt volume flow rate (MVR) for such blends. The thermoplastic composition provides a combination of improved impact performance, including both notched and unnotched Izod impact (NII and UNI, respectively) of greater than or equal to about 4 kJ/m², and greater than or equal to about 80 kJ/m². The thermoplastic composition additionally exhibits improved ductility at low temperatures (−30° C.) compared to comparable impact modified polycarbonates without silicon carbide particles included. Silicon carbide (micro and nano-sized) when used to reinforce a polycarbonate matrix, also resulted in significant increase in the modulus at room temperature. Also surprisingly, addition of SiC to high molecular weight (Mw) PC resulted in a dramatic increase in MVR for the high Mw polycarbonate containing composition, and no significant degradation of the polycarbonate itself was observed. Such thermoplastic compositions of polycarbonates with nano-SiC have also been found to exhibit excellent low temperature properties in tensile and impact tests. Use of SiC can further provide additional benefits in terms of improved hardness, abrasion resistance and flame retardancy to articles molded from the thermoplastic composition comprising polycarbonate and silicon carbide particles. Addition of SiC particles to a polycarbonate composition can also result in a dramatic improvement in the flame retardance of the composition, by decreasing the thickness necessary to achieve a V0 rating to less than or equal to 1.6 mm, specifically less than or equal to 1.5 mm, more specifically less than or equal to 1.2 mm, still more specifically less then or equal to 1.0 mm, and still more specifically less than or equal to 0.8 mm when tested according to UL 94. In the thermoplastic composition, with SiC included as a filler in amounts of up to about 20 wt % of the total weight of the composition, V0 values at thicknesses as low as 0.7 mm can be achieved.

Thus, filled thermoplastic molding compositions for applications requiring high flow and high modulus at room temperature that incorporate high molecular weight polycarbonates in which high melt flow is required can be prepared using silicon carbide particulate filler, with improvements to the mechanical and physical properties of the overall composition. In addition, an increase in modulus at room temperature, and very good retention of ductility at −30° C. can be obtained. The concept can in principle be utilized for any thermoplastic to obtain the improvement in flow and tensile properties while maintaining a good balance between modulus and ductility at low temperatures. It is contemplated that other thermoplastics matrix such as ABS, polyesters, polypropylene (PP), polyethylene (PE), polyphenylene oxide (PPO) and the like can thereby be reinforced with similar benefits. Additionally, compositions prepared according to the present invention can provide improved hardness and abrasion resistance because of the intrinsic hardness of silicon carbide.

In an embodiment, the thermoplastic composition has a melt volume rate (MVR) of greater than or equal to about 5 cc/10 min., specifically greater than about 6 cc/10 min., more specifically greater than about 7 cc/10 min., and still more specifically greater than about 8 cc/10 min., when measured at a temperature of 300° C. under a load of 1.2 kg, according to ISO 1133. In another embodiment, the thermoplastic composition has an MVR of less than about 40 cc/10 min., specifically less than about 35 cc/10 min., and still more specifically less than about 30 cc/10 min., when measured at a temperature of 300° C. under a load of 1.2 kg, according to ISO 1133.

In another embodiment, the thermoplastic composition has a melt volume rate (MVR) of greater than about 40 cc/10 min., specifically greater than or equal to about 45 cc/10 min., and more specifically greater than or equal to about 50 cc/10 min., when measured at a temperature of 300° C. under a load of 5 kg, according to ISO 1133. In a specific embodiment, the thermoplastic composition has a melt volume rate (MVR) of greater than about 54 cc/10 min., specifically greater than or equal to about 100 cc/10 min., and more specifically greater than or equal to about 200 cc/10 min., when measured at a temperature of 300° C. under a load of 5 kg, according to ISO 1133. In another embodiment, the thermoplastic composition has an MVR of less than about 1,500 cc/10 min., specifically less than about 1,000 cc/10 min, and more specifically less than about 950 cc/10 min, when measured at a temperature of 300° C. under a load of 5 kg, according to ISO 1133.

In another embodiment, the thermoplastic composition has an MVR of greater than or equal to about 12 cc/30 sec., specifically greater than or equal to about 14 cc/30 sec., and more specifically greater than or equal to about 14.5 cc/30 sec., when measured at a temperature of 300° C. under a load of 2.16 kg, according to ISO 1133. In another embodiment, the thermoplastic composition has an MVR of less than or equal to about 50 cc/30 sec., specifically less than or equal to about 40 cc/30 sec., and still more specifically less than or equal to about 35 cc/30 sec., when measured at a temperature of 300° C. under a load of 2.16 kg, according to ISO 1133.

In another embodiment, an article molded from the thermoplastic composition has a notched Izod impact (NII) of greater than or equal to about 4 kJ/m², specifically greater than or equal to about 4.5 kJ/m², more specifically greater than or equal to about 5 kJ/m², and still more specifically greater than or equal to about 6 kJ/m², and still more specifically greater than or equal to about 6.5 kJ/m² when measured at a temperature of 23° C. and using a 2.7 J hammer, according to ISO 180. Also in an embodiment, an article molded from the thermoplastic composition has an NII of less than or equal to about 60 kJ/m², specifically less than or equal to about 55 kJ/m², and more specifically less than or equal to about 50 kJ/m when measured at a temperature of 23° C. and using a 2.7 J hammer, according to ISO 180.

In another embodiment, an article molded from the thermoplastic composition has an unnotched Izod impact (UNI) of greater than or equal to about 80 kJ/m², specifically greater than or equal to about 85 kJ/m 2, more specifically greater than or equal to about 90 kJ/m², and still more specifically greater than or equal to about 95 kJ/m², and still more specifically greater than or equal to about 100 kJ/m² when measured at a temperature of 23° C. and using a 2.7 J hammer, according to ISO 180. Also in an embodiment, an article molded from the thermoplastic composition has a UNI of less than or equal to about 260 kJ/m², specifically less than or equal to about 250 kJ/m², and more specifically less than or equal to about 230 kJ/m² when measured at a temperature of 23° C. and using a 2.7 J hammer, according to ISO 180.

In an embodiment, a statistically significant number of articles molded from the thermoplastic composition can have a low temperature ductility as determined by multi axial impact (MAI) of greater than or equal to 10.2%, specifically greater than or equal to about 15%, and still more specifically greater than or equal to about 20%, when measured using a 3.2 mm molded disk at −30° C., according to ISO 6602.

In addition to the polycarbonate, silicon carbide particles, and impact modifier where desired and as described hereinabove, the thermoplastic composition can further include various other additives ordinarily incorporated with thermoplastic compositions of this type, with the proviso that the additives are selected so as not to adversely affect the desired properties of the thermoplastic composition. Mixtures of additives may be used. Such additives may be mixed at a suitable time during the mixing of the components for forming the thermoplastic composition.

The thermoplastic composition may include fillers or reinforcing agents. Where used, suitable fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide (not identical to the silicon carbide microparticles and nanoparticles disclosed hereinabove), alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide (not identical to the silicon carbide microparticles and nanoparticles disclosed hereinabove), aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

The fillers may be coated with a layer of metallic material to facilitate conductivity where desired, or surface treated with silanes to improve adhesion, dispersion, and/or optical properties with the polymeric matrix resin. Where used, fillers can be present in amounts of 0 to 90 parts by weight, based on the total weight of polycarbonate, silicon carbide particles, and an impact modifier.

The thermoplastic composition can include an antioxidant. Useful antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants can be used in amounts of 0.0001 to 1 parts by weight, based on the total weight of polycarbonate, silicon carbide particles, and an impact modifier.

Useful heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers can be used in amounts of 0.0001 to 1 parts by weight, based on the total weight of polycarbonate, silicon carbide particles, and an impact modifier.

Light stabilizers and/or ultraviolet light (UV) absorbing additives may also be used. Useful light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers can be used in amounts of 0.0001 to 1 parts by weight, based on the total weight of polycarbonate, silicon carbide particles, and an impact modifier.

Useful UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB® 531); 2-[4,6-bis(2,4-dimethylphenyl)-1,3,5-triazin-2-yl]-5-(octyloxy)-phenol (CYASORB® 1164); 2,2′-(1,4-phenylene)bis(4H-3,1-benzoxazin-4-one) (CYASORB® UV-3638); 1,3-bis[(2-cyano-3,3-diphenylacryloyl)oxy]-2,2-bis[[(2-cyano-3,3-diphenylacryloyl)oxy]methyl]propane (UVINUL® 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations comprising at least one of the foregoing UV absorbers. UV absorbers can be used in amounts of 0.0001 to 1 parts by weight, based on the total weight of polycarbonate, silicon carbide particles, and an impact modifier.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.001 to 1 parts by weight, based on the total weight of polycarbonate, silicon carbide particles, and an impact modifier.

The thermoplastic composition can include antistatic agents. The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT® 6321 (Sanyo) or PEBAX® MH1657 (Atofina), IRGASTAT® P18 and P22 (Ciba-Geigy). Other polymeric materials that may be used as antistatic agents are inherently conducting polymers such as polyaniline (commercially available as PANIPOL®EB from Panipol), polypyrrole, and polythiophenes such as for example poly(3,4-ethylenedioxythiophene) (commercially available from H. C. Stark), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents can be used in amounts of 0.0001 to 5 parts by weight, based on the total weight of polycarbonate, silicon carbide particles, and an impact modifier.

The thermoplastic composition can include flame retardants. Flame retardant that may be added may be organic compounds that include phosphorus, bromine, and/or chlorine. Non-brominated and non-chlorinated phosphorus-containing flame retardants may be preferred in certain applications for regulatory reasons, for example organic phosphates and organic compounds containing phosphorus-nitrogen bonds.

One type of exemplary organic phosphate is an aromatic phosphate of the formula (GO)₃P═O, wherein each G is independently an alkyl, cycloalkyl, aryl, alkylaryl, or arylalkyl group, provided that at least one G is an aromatic group. Two of the G groups may be joined together to provide a cyclic group, for example, diphenyl pentaerythritol diphosphate. Other useful aromatic phosphates may be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl)phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below:

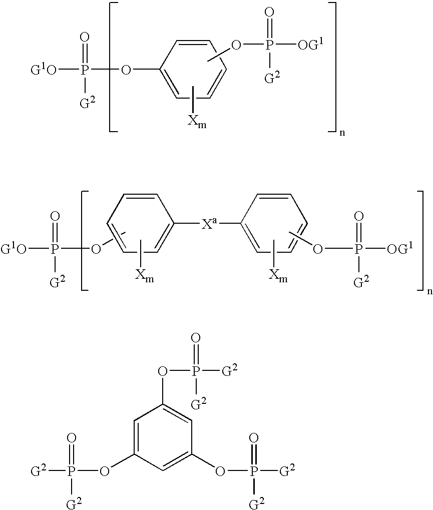

wherein each G¹ is independently a hydrocarbon having 1 to 30 carbon atoms; each G² is independently a hydrocarbon or hydrocarbonoxy having 1 to 30 carbon atoms; each X^{a} is independently a hydrocarbon having 1 to 30 carbon atoms; each X is independently a bromine or chlorine; m is 0 to 4, and n is 1 to 30. Examples of useful di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like.

Exemplary flame retardant compounds containing phosphorus-nitrogen bonds include phosphonitrilic chloride, phosphorus ester amides, phosphoric acid amides, phosphonic acid amides, phosphinic acid amides, tris(aziridinyl) phosphine oxide. When present, phosphorus-containing flame retardants can be present in amounts of 0.1 to 10 parts by weight, based on the total weight of polycarbonate, silicon carbide particles, and an impact modifier.

Halogenated materials may also be used as flame retardants, for example halogenated compounds and resins of formula (20):

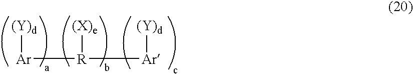

wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (20) are each independently mono- or polycarbocyclic aromatic groups such as phenylene, biphenylene, terphenylene, naphthylene, or the like. Also in formula (20), Y is an organic, inorganic, or organometallic radical, for example: halogen, e.g., chlorine, bromine, iodine, fluorine; ether groups of the general formula OE, wherein E is a monovalent hydrocarbon radical similar to X; monovalent hydrocarbon groups of the type represented by R; or other substituents, e.g., nitro, cyano, and the like, said substituents being essentially inert provided that there is at least one and preferably two halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and arylalkyl group such as benzyl, ethylphenyl, or the like; a cycloaliphatic group such as cyclopentyl, cyclohexyl, or the like. The monovalent hydrocarbon group may itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c may be 0. Otherwise either a or c, but not both, may be 0. Where b is 0, the aromatic groups are joined by a direct carbon-carbon bond.

The hydroxyl and Y substituents on the aromatic groups, Ar and Ar′, can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant. When present, halogen containing flame retardants can be present in amounts of 0.1 to 10 parts by weight, based on the total weight of polycarbonate, silicon carbide particles, and an impact modifier.

Inorganic flame retardants may also be used, for example salts of C₂₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complexes such as Li₃AlF₆, BaSiF₆, KBF₄, K₃AlF₆, KAlF₄, K₂SiF₆, and/or Na₃AlF₆ or the like. When present, inorganic flame retardant salts can be present in amounts of 0.1 to 5 percent by weight, based on the total weight of polycarbonate, silicon carbide particles, and an impact modifier.

The thermoplastic composition can include an anti-drip agent. Anti-drip agents may be, for example, a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A useful TSAN may comprise, for example, 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. Antidrip agents can be used in amounts of 0.1 to 5 parts by weight, based on the total weight of polycarbonate, silicon carbide particles, and an impact modifier.

Radiation stabilizers may also be present, specifically gamma-radiation stabilizers. Exemplary radiation stabilizing additives include certain aliphatic alcohols, aromatic alcohols, aliphatic diols, aliphatic ethers, esters, diketones, alkenes, thiols, thioethers and cyclic thioethers, sulfones, dihydroaromatics, diethers, nitrogen compounds, or a combination comprising at least one of the foregoing. Specific useful radiation stabilizer compounds include diols, such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; alicyclic alcohols such as 1,2-cyclopentanediol, 1,2-cyclohexanediol, and the like; branched acyclic diols such as 2,3-dimethyl-2,3-butanediol (pinacol), and the like, and polyols, as well as alkoxy-substituted cyclic or acyclic alkanes. Alkenols, with sites of unsaturation, are also a useful class of alcohols, examples of which include 4-methyl-4-penten-2-ol, 3-methyl-pentene-3-ol, 2-methyl-4-penten-2-ol, 2,4-dimethyl-4-pene-2-ol, and 9-decen-1-ol. Another class of suitable alcohols is the tertiary alcohols, which have at least one hydroxy substituted tertiary carbon. Examples of these include 2-methyl-2,4-pentanediol (hexylene glycol), 2-phenyl-2-butanol, 3-hydroxy-3-methyl-2-butanone, 2-phenyl-2-butanol, and the like, and cycloaliphatic tertiary carbons such as 1-hydroxy-1-methyl-cyclohexane. Another class of suitable alcohols is hydroxymethyl aromatics, which have hydroxy substitution on a saturated carbon attached to an unsaturated carbon in an aromatic ring. The hydroxy substituted saturated carbon may be a methylol group (—CH₂OH) or it may be a member of a more complex hydrocarbon group such as would be the case with (—CR⁴HOH) or (—CR⁴₂⁴OH) wherein R⁴ is a complex or a simple hydrocarbon. Specific hydroxy methyl aromatics may be benzhydrol, 1,3-benzenedimethanol, benzyl alcohol, 4-benzyloxy benzyl alcohol and benzyl benzyl alcohol. Specific alcohols are 2-methyl-2,4-pentanediol (also known as hexylene glycol), polyethylene glycol, and polypropylene glycol.

Useful aliphatic ethers may include alkoxy-substituted cyclic or acyclic alkanes such as, for example, 1,2-dialkoxyethanes, 1,2-dialkoxypropanes, 1,3-dialkoxypropanes, alkoxycyclopentanes, alkoxycyclohexanes, and the like. Ester compounds which have proven useful include tetrakis(methylene[3,5-di-t-butyl-4-hydroxy-hydrocinnamate])methane, 2,2′-oxamido bis(ethyl-3-(3,5-di-t-butyl-4-hydroxyphenyl) propionate, and trifunctional hindered phenolic ester compounds such as GOOD-RITE® 3125, available from B.F. Goodrich in Cleveland Ohio. Diketone compounds may also be used, such as, for example 2,4-pentadione. Sulfur-containing compounds, useful can include thiols, for example, 2-mercaptobenzothiazole; thioethers such as dilaurylthiopropionate; and cyclic thioethers such as 1,3- and 1,4-dithiane, and 1,4,8,11-tetrathiocyclotetradecane. Aryl or alkyl sulfone stabilizing additives of general structure R—S(O)₂—R′ may also be used, where R and R′ comprise C₁-C₂₀ alkyl or alkoxy, or C₆-C₂₀ aryl or aryloxy, and the like, wherein at least one of R or R′ is a benzyl. An example of a specifically useful sulfone is benzylsulfone.

Alkenes may be used as stabilizing additives. Useful alkenes may include olefins of general structure RR′C═CR″R′″ wherein R, R′, R″, and R′″ are C₁-C₂₀ aliphatic or aromatic groups and may each individually be the same or different. The olefins may be acyclic, exocyclic, or endocyclic. Examples of specifically useful alkenes include 1,2-diphenyl ethane, allyl phenol, 2,4-dimethyl-1-pentene, limonene, 2-phenyl-2-pentene, 2,4-dimethyl-1-pentene, 1,4-diphenyl-1,3-butadiene, 2-methyl-1-undecene, 1-dodecene, and the like. Hydroaromatic compounds may also be useful as stabilizing additives, including indane, 5,6,7,8-tetrahydro-1-naphthol, 5,6,7,8-tetrahydro-2-naphthol, 9,10-dihydroanthracene, 9,10-dihydrophenanthrene, 1-phenyl-1-cyclohexane, 1,2,3,4-tetrahydro-1-naphthol, and the like. Diethers, including pyrans, may also be used as stabilizing additives. Hydrogenated pyrans are specifically useful. Examples of diethers include dihydropyranyl ethers and tetrahydropyranyl ethers. Nitrogen compounds which may function as stabilizers include high molecular weight oxamide phenolics, for example, 2,2-oxamido bis-[ethyl 3-(3,5-di-tert-butyl-4-hydroxyphenyl)propionate], high molecular weight oxalic anilides and their derivatives, and amine compounds such as thiourea.

Radiation stabilizing additives are typically used in amounts of 0.001 to 1 parts by weight, specifically 0.005 to 0.75 parts by weight, more specifically 0.01 to 0.5 parts by weight, and still more specifically 0.05 to 0.25 parts by weight, based on the total weight of polycarbonate, silicon carbide particles, and an impact modifier. In an embodiment, a specifically useful radiation stabilizing additive is an aliphatic diol.

In one embodiment, the thermoplastic composition comprises about 49.9 to about 99.9 parts by weight of the polycarbonate polymer, up to about 50 parts by weight of the impact modifier, and about 0.1 to about 30 parts by weight silicon carbide particles, wherein the amounts of the polycarbonate polymer, impact modifier, and silicon carbide are each based on 100 parts by weight of the polycarbonate, silicon carbide particles, and impact modifier. In another embodiment, the thermoplastic composition comprises about 49.9 to about 94.9 parts by weight of a polycarbonate polymer having an MVR measured at 300° C. under a load of 1.2 kg according to ASTM D1238-04 or ISO 1133, of 0.5 to 20 cc/10 min, about 0.1 to about 50 parts by weight of an impact modifier, and about 5 to about 15 parts by weight silicon carbide particles, wherein the amounts of the polycarbonate polymer, impact modifier, and silicon carbide are each based on 100 parts by weight of the polycarbonate, silicon carbide particles, and impact modifier. While it is contemplated that other resins and or additives may be used in the thermoplastic compositions described herein, such additives while desirable in some embodiments are not essential. Thus, in an embodiment, a thermoplastic composition consists essentially of a polycarbonate polymer, silicon carbide particles, and impact modifier excluding any other additives and/or fillers. In an embodiment, polycarbonates specifically useful in the thermoplastic polymer include homopolycarbonates, copolycarbonates, polyester-polycarbonates, polysiloxane-polycarbonates, and combinations comprising at least one of the foregoing polycarbonate-type resins. In a specific embodiment, the thermoplastic composition consists of polycarbonate, silicon carbide, and an impact modifier.

In a further embodiment, the thermoplastic composition may comprise an additive including optical effects filler, antioxidant, heat stabilizer, light stabilizer, ultraviolet light absorber, plasticizer, mold release agent, lubricant, antistatic agent, flame retardant, anti-drip agent, gamma stabilizer, or a combination comprising at least one of the foregoing additives.

The thermoplastic composition may be manufactured by methods generally available in the art, for example, in one embodiment, in one manner of proceeding, powdered polycarbonate, SiC, and any impact modifier are first blended, in a HENSCHEL-Mixer® high speed mixer. Other low shear processes including but not limited to hand mixing may also accomplish this blending. The blend is then fed into the throat of an extruder via a hopper. Alternatively, one or more of the components may be incorporated into the composition by feeding directly into the extruder at the throat and/or downstream through a sidestuffer. Additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate may be one-fourth inch long or less as desired. Such pellets may be used for subsequent molding, shaping, or forming.

In a specific embodiment, a method of preparing a thermoplastic composition comprises melt combining a polycarbonate, silicon carbide particles, and an impact modifier. The melt combining can be done by extrusion. In an embodiment, the proportions of polycarbonate, silicon carbide particles, and an impact modifier are selected such that the optical properties of the thermoplastic composition are maximized while mechanical performance is at a desirable level. In a further specific embodiment, the thermoplastic polymer comprises a polycarbonate-type polymer as defined hereinabove. In an embodiment, a method of preparing a thermoplastic composition comprises melt blending a masterbatch comprising polycarbonate, silicon carbide particles, and an impact modifier, with an additional thermoplastic polymer. In an embodiment, the proportions of polycarbonate, silicon carbide particles, and an impact modifier are selected such that the optical properties of the thermoplastic composition are maximized while mechanical performance is at a desirable level.

In a specific embodiment, the extruder is a twin-screw extruder. The extruder is typically operated at a temperature of 180 to 385° C., specifically 200 to 330° C., more specifically 220 to 300° C., wherein the die temperature may be different. The extruded thermoplastic composition is quenched in water and pelletized.

Shaped, formed, or molded articles comprising the thermoplastic compositions are also provided. The thermoplastic compositions may be molded into useful shaped articles by a variety of means such as injection molding, extrusion, rotational molding, blow molding and thermoforming. In a specific embodiment, molding is done by injection molding. Desirably, the thermoplastic composition has excellent mold filling capability due to its high flow properties.

The thermoplastic composition is useful to form article requiring hybrid composite materials, and in particular can be used in diverse manufacturing applications such as those in the electrical/electronic fields, automotive manufacturing, aerospace manufacturing, and the like.

The thermoplastic composition is further illustrated by the following non-limiting examples.

All thermoplastic compositions were compounded on a ZSK 25-mm twin-screw extruder to achieve the high flow and high performance thermoplastic composite having micro and nano sized SiC particles incorporated into the PC matrix. The twin-screw extruder had enough distributive and dispersive mixing elements to produce good mixing of the polymer compositions. The compositions were subsequently molded according to ISO 294 on a Husky or BOY injection-molding machine. Compositions were compounded and molded at a temperature of 250 to 330° C., though it will be recognized by one skilled in the art that the method is not limited to these temperatures.

Thermoplastic compositions for the examples (abbreviated Ex. in the following tables) and comparative examples (abbreviated CEx. in the following tables) were prepared using the individual components described in Table 1. Properties of the thermoplastic compositions were determined herein as follows. Molecular weight of polymers (Mn, Mw, and polydispersity) was determined using gel permeation chromatography using a crosslinked styrene-divinylbenzene column, a sample concentration of about 1 mg/ml, and an elution rate of toluene or chloroform eluent of 0.5 to 1.5 ml/min. Values for elongation at break (%) for molded articles were determined according to ISO 527 at a temperature of 23° C. Values for elastic modulus (in gigapascals, GPa) were determined according to ISO 527. Values of notched Izod impact (NII) and unnotched Izod impact (UNI) (in units of kJ/m²) were determined according to ISO 180. Values of melt-volume flow rate (MVR) were determined at 300° C. under loads of 1.2 or 5 kg (in cc/10 min) or under a load of 2.16 kg (in cc/30 sec), according to ISO 1133. Coefficient of thermal expansion (CTE) in units of in/in ° F. (ppm) was determined according to ASTM E832. Tensile modulus (MPa) was determined according to ISO 527. Yield stress (MPa) was determined according to ISO 527. MAI (Multi Axial Impact) (J) was determined using 3.2 mm disks according to ISO 6602. Heat distortion/deflection temperature (HDT) (° C.) was determined flatwise at 1.8 MPa according to ASTM D648-06.

Flammability tests were performed following the procedure of Underwriter's Laboratory Bulletin 94 entitled “Tests for Flammability of Plastic Materials, UL94”. Several ratings can be applied based on the rate of burning, time to extinguish, ability to resist dripping, and whether or not drips are burning. Samples for testing are bars having dimensions of 125 mm length×13 mm width by no greater than 13 mm thickness. Bar thicknesses used herein are 1.6 mm or 0.7 mm thick. Materials can be classified according to this procedure as UL 94 HB (horizontal burn), V0, V1, V2, 5VA and/or 5VB on the basis of the test results obtained for five samples; however, the compositions herein were tested and classified only as V0, V1, and V2, the criteria for each of which are described below.

V0: In a sample placed so that its long axis is 180 degrees to the flame, the period of flaming and/or smoldering after removing the igniting flame does not exceed ten (10) seconds and the vertically placed sample produces no drips of burning particles that ignite absorbent cotton. Five bar flame out time is the flame out time for five bars, each lit twice, in which the sum of time to flame out for the first (t₁) and second (t₂) ignitions is less than or equal to a maximum flame out time (t₁+t₂) of 50 seconds.

V1: In a sample placed so that its long axis is 180 degrees to the flame, the period of flaming and/or smoldering after removing the igniting flame does not exceed thirty (30) seconds and the vertically placed sample produces no drips of burning particles that ignite absorbent cotton. Five bar flame out time is the flame out time for five bars, each lit twice, in which the sum of time to flame out for the first (t₁) and second (t₂) ignitions is less than or equal to a maximum flame out time (t₁+t₂) of 250 seconds.

V2: In a sample placed so that its long axis is 180 degrees to the flame, the average period of flaming and/or smoldering after removing the igniting flame does not exceed thirty (30) seconds, but the vertically placed samples produce drips of burning particles that ignite cotton. Five bar flame out time is the flame out time for five bars, each lit twice, in which the sum of time to flame out for the first (t₁) and second (t₂) ignitions is less than or equal to a maximum flame out time (t₁+t₂) of 250 seconds.

The materials used to prepare the compositions of the following examples and comparative examples herein below are listed in Table 1.

TABLE 1

| Component | Supplier, Grade | Description |
|---|---|---|
| HRG | SABIC Innovative | Emulsion rubber graft with about 50% |
| | Plastics | Polybutadiene |
| PC-1 | SABIC Innovative | Bisphenol A polycarbonate having a melt |
| | Plastics | volume rate (MFR) of 5.1-6.9 cc/10 |
| | | minutes measured at 300° C. and 1.2 |
| | | kilograms load (Low Flow) |
| PC-2 | SABIC Innovative | Bisphenol A polycarbonate having a melt |
| | Plastics | flow rate (MFR) of 6-14 cc/10 minutes |
| | | measured at 300° C. and 1.2 kilograms |
| | | load (High Flow) |
| PCST | SABIC Innovative | Bisphenol A polycarbonate- |
| | Plastics | polydimethylsiloxane copolymer (20 wt % siloxane) |
| SAN | SABIC Innovative | Poly(styrene-co-acrylonitrile) having a |
| | Plastics | polystyrene content of 75 weight percent |
| | | and a polyacrylonitrile content of 25 |
| | | weight percent |
| ABS (bulk) | SABIC Innovative | High rubber graft emulsion polymerized |
| | Plastics | poly(acrylonitrile-co-butadiene-co- |
| | | styrene) comprising 15-35 weight percent |
| | | polyacrylonitrile and 85-65 weight |
| | | percent polystyrene grafted on to a core |
| | | of 85-100 weight percent polybutadiene |
| | | and with a 15-0 weight percent styrene; |
| | | the core represents 25-75% of the total |
| | | emulsion ABS; the materials are |
| | | crosslinked to a density of 43-55% as |
| | | measured by sol-gel fraction. |
| TSAN | SABIC Innovative | PTFE encapsulated 72:28 w/w styrene- |
| | Plastics | acrylonitrile copolymer |
| SiC 100R | Grade B 100R | Silicon Carbide microparticles having |
| | Snam Abrasives | average particle sizes D₅₀ of 122 μm, and |
| | (India) | total composition of particles <3 wt % of |
| | | particles at a max particle size of 150 μm |
| SiC 180R | Grade B 180R | Silicon Carbide microparticles having |
| | Snam Abrasives | average particle sizes D₅₀ of 76 μm, and |
| | (India) | total composition of particles <3 wt % of |
| | | particles at a max particle size of 90 μm |
| SiC 220R | Grade B 220R | Silicon Carbide microparticles having |
| | Snam Abrasives | average particle sizes D₅₀ of 63 μm, and |
| | (India) | total composition of particles <3 wt % of |
| | | particles at a max particle size of 75 μm |
| SiC 240R | Grade B 240R | Silicon Carbide microparticles having |
| | Snam Abrasives | average particle sizes D₅₀ of 50 μm, and |
| | (India) | total composition of particles <3 wt % of |
| | | particles at a max particle size of 70 μm |
| SiC 280R | Grade B 280R | Silicon Carbide microparticles having |
| | Snam Abrasives | average particle sizes D₅₀ of 37 μm, and |
| | (India) | total composition of particles <3 wt % of |
| | | particles at a max particle size of 59 μm |
| SiC 320R | Grade B 320R | Silicon Carbide microparticles having |
| | Snam Abrasives | average particle sizes D₅₀ of 29 μm, and |
| | (India) | total composition of particles <3 wt % of |
| | | particles at a max particle size of 49 μm |
| SiC 400R | Grade B 400R | Silicon Carbide microparticles having |
| | Snam Abrasives | average particle sizes D₅₀ of 17 μm, and |
| | (India) | total composition of particles <3 wt % of |
| | | particles at a max particle size of 32 μm |
| SiC 600R | Grade B 600R | Silicon Carbide microparticles having |
| | Snam Abrasives | average particle sizes D₅₀ of 9 μm, and |
| | (India) | total composition of particles <3 wt % of |
| | | particles at a max particle size of 19 μm |
| SiC 800R | Grade B 800R | Silicon Carbide microparticles having |
| | Snam Abrasives | average particle sizes D₅₀ of 7 μm, and |
| | (India) | total composition of particles <3 wt % of |
| | | particles at a max particle size of 14 μm |
| SiC 1200R | Grade B 1200R | Silicon Carbide microparticles having |
| | Snam Abrasives | average particle sizes D₅₀ of 3 μm, and |
| | (India) | total composition of particles <3 wt % of |
| | | particles at a max particle size of 7 μm |
| SiC-FCP15 | SiC nanoparticles, | Silicon Carbide nanoparticles having |
| | Saint-Gobain | average particle sizes D₅₀ of 50 nm. |
| Epoxy treated | SiC nanoparticles, | Epoxy-treated Silicon Carbide |
| FCP15 | Saint-Gobain | nanoparticles having average particle |
| | (with laboratory | sizes D₅₀ of 50 nm |
| | applied epoxy | |
| | coating) | |
| SiC-FCP15C | Coated SiC | Coated Silicon Carbide nanoparticles |
| | nanoparticles, | having average particle size D₅₀ of 50 nm |
| | Saint-Gobain | (proprietary coating) |
| Talc | SABIC Innovative | Talc microparticles having an average |
| | Plastics | particle size D₅₀ of 100 to 150 μm |
| RDP | Flame retardant | resorcinol tetraphenyl diphosphate |
| IRGANOX ® 1076 | Antioxidant | |
| | Ciba Specialty | |
| | Chemicals | |
| IRGAPHOS ® 168 | Antioxidant, | Tris(2,4-di-tert-butylphenyl)phosphite |
| | Ciba Specialty | |
| | Chemicals | |
| PETS | Lonza, | Pentaerythritol tetrastearate |
| | GLYCOLUBE ® | |
| | release agent | |

### Method for Preparing Epoxy-Treated Silicon Carbide Nanoparticles.

Silicon carbide nanoparticles (10 g of FCP-15, from Saint Gobain), were slurried in 100 ml of acetone. Bisphenol-A diglycidyl ether (0.5 g, DGEBA) was dissolved in this suspension. The slurry was thoroughly mixed using a magnetic stirrer, at room temperature for 12 hours. The acetone was removed from the slurry by evaporation at room temperature. The solid mass remaining was 5% by weight DGEBA-treated SiC FCP15.

### EXAMPLES 1-7 AND COMPARATIVE EXAMPLES 1-5

Thermoplastic compositions were prepared as described according to the proportions in Table 2 for Examples 1-7, and for Comparative Examples 1-5. Silicon carbide was included in each of the examples in amounts of 4.8 or 5 parts by weight per 100 parts (except for Example 7). No SiC was included in the comparative examples. SiC particles used for these examples had a particle size of 7 to 20 micrometers (SiC 600R). The results are shown in Table 2, below.

TABLE 2

| | | Ex. 1^{a} | Ex. 2^{a} | Ex. 3^{b} | | | | | Ex. 6^{a} | | Ex. 7^{b} |
|---|---|---|---|---|---|---|---|---|---|---|---|
| | CEx. 1^{a} | SiC w/o | SiC, | 5 phr | CEx. 2 | CEx. 3 | Ex. 4^{a} | Ex. 5^{a} | SiC, | CEx. 5^{a} | 5 phr |
| | Base | SAN | SAN | SiC | PC-2 | PC-1 | PC-2 | PC-1 | talc | Control | SiC |
| HRG | 4.4 | 4.4 | 4.4 | 4.4 | 0.0 | 0.0 | 0.0 | 0.0 | 7.9 | 18.0 | 18.0 |
| PC-1 | 51.0 | 51.0 | 46.2 | 51.0 | 0.0 | 100.0 | 0.0 | 95.0 | 50.6 | 15.0 | 15.0 |
| PC-2 | 23.1 | 23.1 | 23.1 | 23.1 | 100.0 | 0.0 | 95.0 | 0.0 | 22.9 | 38.5 | 38.5 |
| TSAN | 3.9 | 3.9 | 3.9 | 3.9 | 0.0 | 0.0 | 0.0 | 0.0 | 0.0 | 0.0 | 0.0 |
| SiC 600R | 0.0 | 4.8 | 4.8 | 5.0 | 0.0 | 0.0 | 5.0 | 5.0 | 5.0 | 0.0 | 5.0 |
| SAN | 4.8 | 0.0 | 4.8 | 4.8 | 0.0 | 0.0 | 0.0 | 0.0 | 5.0 | 28.0 | 28.0 |
| Talc | 12.2 | 12.2 | 12.2 | 12.2 | 0.0 | 0.0 | 0.0 | 0.0 | 7.9 | 0.0 | 0.0 |
| IRGANOX ® 1076 | 0.3 | 0.3 | 0.3 | 0.3 | 0.0 | 0.0 | 0.0 | 0.0 | 0.3 | 0.1 | 0.1 |
| IRGAPHOS ® 168 | 0.1 | 0.1 | 0.1 | 0.1 | 0.0 | 0.0 | 0.0 | 0.0 | 0.1 | 0.1 | 0.1 |
| PETS | 0.3 | 0.3 | 0.3 | 0.3 | 0.0 | 0.0 | 0.0 | 0.0 | 0.3 | 0.3 | 0.3 |
| Total (phr) | 100 | 100 | 100 | 105 | 100 | 100 | 100 | 100 | 100 | 100 | 105 |
| Elastic Modulus (GPa) | 4.6 | 4.2 | 4.4 | 4.2 | — | — | 2.5 | 2.5 | 3.3 | 2.1 | 2.6 |
| @ RT | | | | | | | | | | | |
| Elongation @ Break (%) | 10.2 | 27.5 | 18.7 | 15.4 | — | — | 5.1 | 52.7 | 24.6 | 37.1 | 35.4 |
| NII (kJ/m²) @ RT | 26.9 | 27.5 | 45.8 | 31.3 | — | — | 16.7 | 12.6 | 22.1 | 49.2 | 53.3 |
| UNI (kJ/m²) @ RT | NB | NB | NB | NB | NB | NB | NB | NB | NB | NB | NB |
| MVR (cc/10 min., | 8.9 | 8.1 | 7.8 | 9.5 | 21 | 5 | 32.8 | 37.1 | 6 | 20.8 | 21 |
| 300° C./1.2 kg) | | | | | | | | | | | |

^{a}2,000 g total scale
^{b}2,100 g. total scale

In Examples 1-3 in Table 2, each of which contains talc as a filler, it can be seen that in each case % elongation at break increases over the comparative example (CEx. 1) from 10.2% to a minimum of 15.4% (in Ex. 3), with the highest improvement found in the example without added SAN (Ex. 2), at SiC loadings of about 5% by weight. Example 2 with proportionally less high flow PC (PC-2) has higher flow and NII than Example 3. Of Examples 1-3, Example 1, without added SAN, appears to have the best overall balance of properties. However, when compared with Examples 6 and 7, the latter of which is prepared without added talc filler, Example 7 has high overall NII and % elongation, with superior high MVR for high flow applications. Example 6, with comparatively high amounts of low flow PC (PC-1) and talc, has significantly lower MVR than Example 7 without talc.

Interestingly, for compositions having only SiC and low flow or high flow PC (Ex. 4 and Ex. 5, respectively), the MVR is higher for the low flow composition (Ex. 4) than for the high flow composition (CEx. 4), and the % elongation at break for the high flow composition of CEx. 4 is unacceptably low (5.1%), while it is significantly higher (over 50%) for the composition of Ex. 5.

### EXAMPLES 8-14, AND COMPARATIVE EXAMPLE 6

All examples 8-14 and Comparative Example 6 were prepared according to the amounts listed in Table 3. Examples 8-11 were prepared using SiC microparticles (with an average particle size of 9 μm) and Examples 12-14 were prepared using SiC nanoparticles (average particle size is around 50 nm), including epoxy treated nanoparticles in Example 13. The results are shown below in Table 3.

TABLE 3

| | | Ex. 8 | Ex. 9 | Ex. 10 | Ex. 11 | Ex. 12 | Ex. 13 | Ex. 14 |
|---|---|---|---|---|---|---|---|---|
| | CEx. 6 | 5% SiC | 10% SiC | 15% SiC | 20% SiC | 10% SiC- | 10% Epoxy | 10% SiC- |
| | Base | 600R | 600R | 600R | 600R | FCP15 | Treated FCP15 | FCP15C |
| PC-1 | 100.0 | 95.0 | 90.0 | 85.0 | 80.0 | 90.0 | 90.0 | 90.0 |
| SiC | 0.0 | 5.0 | 10.0 | 15.0 | 20.0 | 10.0 | 10.0 | 10.0 |
| IRGANOX ® 1076 | 0.3 | 0.3 | 0.3 | 0.3 | 0.3 | 0.3 | 0.3 | 0.3 |
| IRGAPHOS ® 168 | 0.1 | 0.1 | 0.1 | 0.1 | 0.1 | 0.1 | 0.1 | 0.1 |
| PETS | 0.3 | 0.3 | 0.3 | 0.3 | 0.3 | 0.3 | 0.3 | 0.3 |
| Total (phr) | 100.7 | 100.7 | 100.7 | 100.7 | 100.7 | 100.7 | 100.7 | 100.7 |
| Elastic Modulus (GPa) @ RT | 2.3 | 2.65 | 2.95 | 3.3 | 3.6 | 2.95 | 2.81 | 2.8 |
| Elastic Modulus (GPa) @ −30° C. | — | — | — | — | — | — | — | 4.86 |
| Yield Stress (MPa) @ RT | — | — | — | — | — | 66 | 65 | 65 |
| Yield Stress (MPa) @ −30° C. | — | — | — | — | — | — | — | 103.48 |
| Yield Strain (%) @ RT | — | — | — | — | — | 5.4 | 5.5 | 5.6 |
| Elongation at Break (%) @ RT | ~90 | 15 | 33 | 17 | 10.0 | 17.7 | 76.25 | 75 |
| Break Stress (MPa) @ RT | — | — | — | — | — | 51.6 | 63 | 60.5 |
| Break Strain (%) @ −30° C. | — | — | — | — | — | — | — | 25 |
| NII (kJ/m²) (@ RT) | 10.0 | 6.7 | 7.0 | 4.9 | 3.4 | 2.0 | 12.1 | 10.4 |
| NII (kJ/m²) @ −30° C. | — | — | — | — | — | — | 4.4 | 3.3 |
| UNI (kJ/m²) @ RT | NB | NB | NB | NB | NB | NB | NB | NB |
| UNI (kJ/m²) @ −30° C. | — | — | — | — | — | — | NB | NB |
| MVR (cc/10 min., 300° C./5 kg) | — | 54.3 | 92.4 | 60.9 | 64.5 | — | — | — |
| CTE (X-flow) in/in. ° F. (ppm) | 4 | 2.89 | 3.37 | 3.36 | 3.23 | — | — | — |
| CTE (flow) in/in. ° F. (ppm) | 4 | 2.43 | 2.07 | 2.47 | 2.66 | — | — | — |

In the data in Table 3, it can be clearly seen that increasing amounts of SiC of a consistent particle size leads to a corresponding decrease in NII, and elongation at break for all Examples. However, a dramatic trend in MVR is also noted, with a sharp increase in MVR between Examples 8 (5% SiC, MVR of 54.3 cc/10 min) and 10 (15% SiC MVR of 60.9 cc/10 min.) at Example 9 (10% SiC, MVR of 92.4 cc/10 min under the test conditions). Cross flow CTE shows an increase at 10% SiC loading (Ex. 9) with a leveling off thereafter, but remains roughly constant across all loadings, with a slight decrease at 10% SiC, for the in-flow CTE.

Example 13 with epoxy treated SiC nanoparticles (i.e., epoxy treated FPC15) has better % elongation than unmodified SiC nanoparticles FPC15 (Example 12). Example 14, which are SiC nanoparticles coated by the supplier with a proprietary coating, has comparable % elongation to Example 13 but has lower NII performance.

In the Examples of Table 3, non-impact modified polycarbonate compositions having SiC filler were also tested by UNI and show unbreakable ductility properties (NB) irrespective of SiC filler loading or SiC filler size. Low temperature ductility (−30° C.) is not observed for Comparative Example 6 and Examples 8-12, and there is no impact modifier in the compositions. However, commercially available SiC treated with a proprietary modifier provides low temp ductility (Examples 13 and 14). Generally though, polycarbonate having SiC filler provides both desirable flow and ductility.

### EXAMPLES 15-24, AND COMPARATIVE EXAMPLE 7

All Examples 15-24 (with identical loadings of SiC of 10 wt %) and Comparative Example 6 (without SiC) were prepared according to the amounts listed in Table 4. The particle sizes of the SiC microparticles of Examples 15-24 were varied according to the data provided, to compare the results of different particle sizes at constant loading. The results are shown below in Table 4.

TABLE 4

| PC with 10% SiC | Ex. 15 | Ex. 16 | Ex. 17 | Ex. 18 | Ex. 19 | Ex. 20 | Ex. 21 | Ex. 22 | Ex. 23 | Ex. 24 | CEx 7. |
|---|---|---|---|---|---|---|---|---|---|---|---|
| SiC Grade | 100R | 180R | 220R | 240R | 280R | 320R | 400R | 600R | 800R | 1200R | — |
| Avg. Particle Size (μm) | 122 | 76 | 63 | 50 | 37 | 29 | 17 | 9 | 7 | 3 | — |
| 3% Max., Larger than (μm) | 150 | 90 | 75 | 70 | 59 | 49 | 32 | 19 | 14 | 7 | — |
| PC-1 | 89.5 | 89.5 | 89.5 | 89.5 | 89.5 | 89.5 | 89.5 | 89.5 | 89.5 | 89.5 | 99.5 |
| Silicon Carbide | 10.0 | 10.0 | 10.0 | 10.0 | 10.0 | 10.0 | 10.0 | 10.0 | 10.0 | 10.0 | 0.0 |
| IRGANOX ® 1076 | 0.1 | 0.1 | 0.1 | 0.1 | 0.1 | 0.1 | 0.1 | 0.1 | 0.1 | 0.1 | 0.1 |
| IRGAPHOS ® 168 | 0.1 | 0.1 | 0.1 | 0.1 | 0.1 | 0.1 | 0.1 | 0.1 | 0.1 | 0.1 | 0.1 |
| PETS | 0.3 | 0.3 | 0.3 | 0.3 | 0.3 | 0.3 | 0.3 | 0.3 | 0.3 | 0.3 | 0.3 |
| Total | 100.0 | 100.0 | 100.0 | 100.0 | 100.0 | 100.0 | 100.0 | 100.0 | 100.0 | 100.0 | 100.0 |
| NII (kJ/m²) | 6.50 | 11.52 | 6.87 | 6.93 | 10.65 | 7.37 | 10.49 | 6.77 | 7.60 | 6.84 | — |
| UNI (kJ/m²) | 85.18 | 101.46 | 121.34 | 122.87 | 134.51 | 182.44 | 190.73 | 167.62 | 225.43 | NB | — |
| Tensile Modulus (MPa) | 2821.5 | 2747.9 | 2718.5 | 2739.1 | 2717.0 | 2695.4 | 2812.3 | 2821.3 | 2864.3 | 2815.1 | — |
| Elongation @ Break (%) | 7.56 | 11.28 | 7.88 | 23.28 | 18.57 | 37.31 | 28.09 | 13.76 | 17.76 | 64.66 | — |
| MAI (J) | 54.39 | 46.18 | 44.90 | 51.29 | 86.57 | 72.42 | 68.33 | 42.48 | 70.17 | 62.31 | — |
| Stress @ Yield (MPa) | 51.47 | 54.43 | 55.15 | 54.79 | 56.02 | 54.69 | 56.97 | 58.99 | 60.32 | 60.51 | — |
| MVR (10 cc/30 sec., | 15.37 | 16.81 | 23.02 | 14.56 | 19.86 | 26.06 | 32.21 | 17.08 | 30.86 | 24.09 | — |
| 300° C./2.16 kg) | | | | | | | | | | | |
| Appearance of Drips (UL 94 | No | No | No | No | No | No | No | No | No | No | Drips |
| vertical burn testing @ 1.6 mm | Drip | Drip | Drip | Drip | Drip | Drip | Drip | Drip | Drip | Drip | |
| thickness) | | | | | | | | | | | |
| t₁ + t₂ (sec) (for 5 specimens) | 39 | 25 | 26 | 22 | 23 | 27 | 32 | 25 | 32 | 40 | NA |
| UL 94 Flame Rating @ 1.6 mm | V0 | V0 | V0 | V0 | V0 | V0 | V0 | V0 | V0 | V0 | V2 |
| thickness | | | | | | | | | | | |

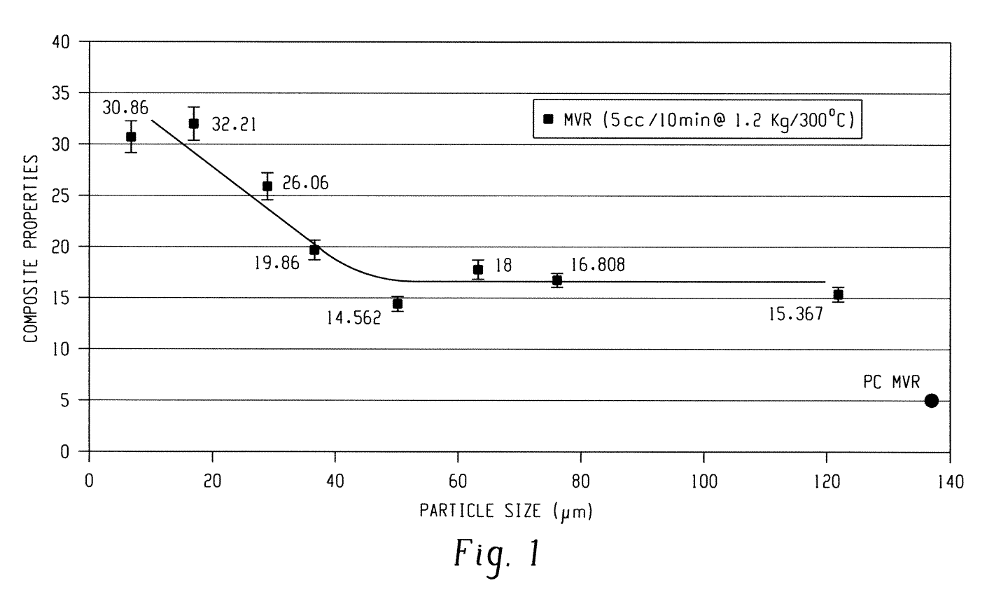

Table 4 shows the effect of particle size on different properties of the low flow PC (PC-1). In FIG. 1, which is a plot of composite properties versus particle size for Table 4 it can be seen that there is a clear leveling effect in properties as particle sizes increase, leveling off at an average particle size of about 60 μm and higher. Particle sizes less than about 60 μm show a steady increase in the composite properties. Table 4 also illustrates the effect of SiC on flammability in which the addition of SiC to PC results in a flammability rating according to UL 94 of V0 irrespective of particle size, at 10 wt % SiC loading and a thickness of 1.6 mm (or less). The FR rating of neat PC resin (without SiC filler) is V2, in which all the samples exhibit dripping in the vertical burn test. However, with the addition of 10 wt % of silicon carbide, samples do not drip

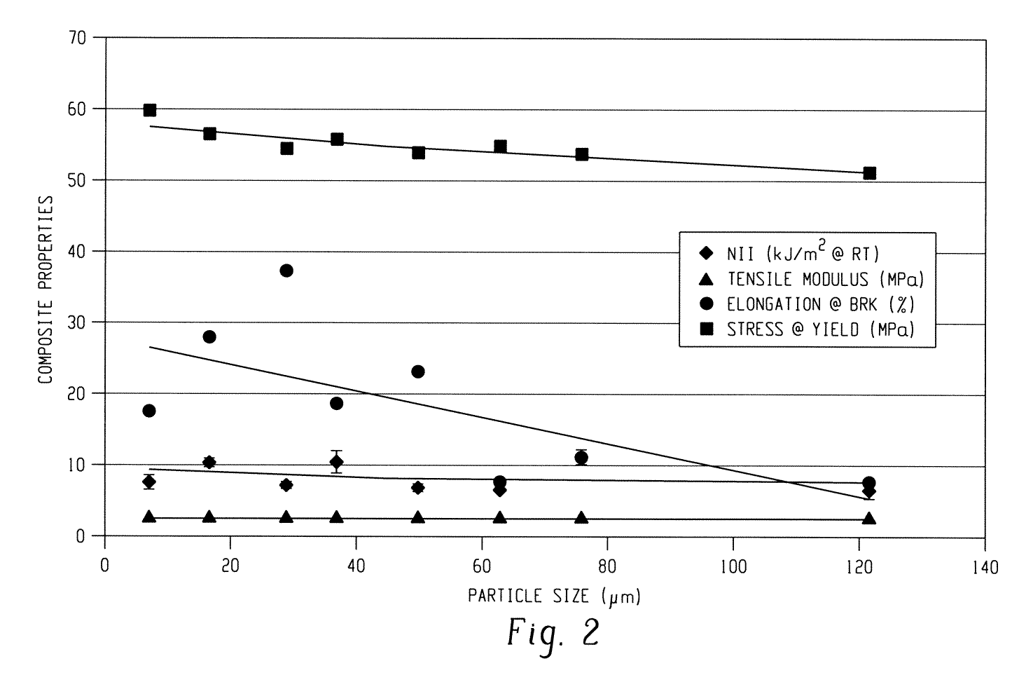

FIG. 2 shows the individual plots of the data of Table 4 for NII, tensile modulus, elongation at break, and yield stress versus average particle size. Of these plotted properties, the greatest change per change in particle size is seen in the elongation at break, which also has the greatest scatter in the data due to test noise. The other properties show a steady decline with increasing particle size. Of note, in Table 4, MVR increases in approximately inverse proportion to particle size, with the greatest affect on MVR being obtained for particle sizes of 17 micrometers (Ex. 21) and 7 micrometers (Ex. 23).

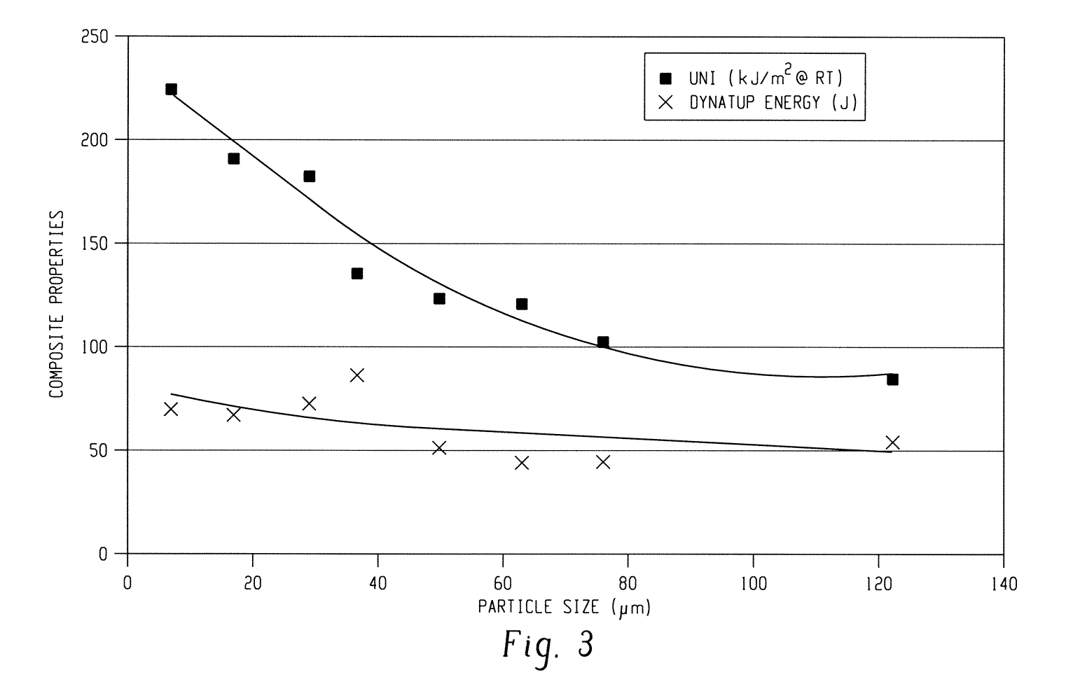

FIG. 3 shows a plot of unnotched Izod (UNI) and dynatup impact (MAI) versus particle size for the data in Table 4. The UNI data and dynatup each show declining values on a parabolic curve fit, but the effect is more pronounced in the UNI data.

### Molecular Weight Data for Examples 21, 23, and Comparative Example 6

Examples 21 and 23, and Comparative Example 6, were tested for change in molecular weight after compounding with SiC to determine the extent if any of degradation of the polycarbonate upon compounding. The results are shown in Table 5, below.

TABLE 5

| | | | PDI | Avg | Avg | Avg |
|---|---|---|---|---|---|---|
| Example | Mn | Mw | (Mw/Mn) | Mn | Mw | PDI |
| CEx. 6 | 38164 | 63288 | 1.66 | 38073 | 63159 | 1.66 |
| BPA-PC | 37982 | 63030 | 1.66 | | | |
| Ex. 23 (7 μm | 35341 | 61695 | 1.75 | 35319.5 | 61733 | 1.75 |
| part. Size) | | | | | | |
| PC + 10% SiC | 35298 | 61771 | 1.75 | | | |
| Ex. 21 (17 μm | 34707 | 58734 | 1.69 | 34748.5 | 58834 | 1.69 |
| part. Size) | | | | | | |
| PC + 10% SiC | 34790 | 58934 | 1.69 | | | |

Table 5 shows the comparative results for molecular weights for a comparative example without added SiC (CEx. 6), a comparative result for a smaller particle (Ex. 23) and for a larger particle (Ex. 21). The results show only a slight decrease in Mw and Mn for the examples, and a slight broadening of the polydispersity for Example 23. The results do not show significant degradation of the polycarbonate under the conditions of compounding or extrusion, in the presence of the SiC filler. Thus, addition of SiC to PC does not degrade PC, and hence the increase in flow of PC is specifically attributable to the effect of SiC particles interacting with the PC.

### EXAMPLES 25-30 AND COMPARATIVE EXAMPLES 7-9

Examples 25-30, and Comparative Examples 7-9, were prepared to further test for the effects on flame retardancy for polycarbonate combinations prepared using SiC (average particle size of 9 μm). The results are shown in Table 6, below.

TABLE 6

| | CEx. 7 | Ex. 25 | Ex. 26 | CEx. 8 | Ex. 27 | Ex. 28 | CEx. 9 | Ex. 29 | Ex. 30 |
|---|---|---|---|---|---|---|---|---|---|
| PC-2 | 34.7 | 34.8 | 34.8 | 40.0 | 40.0 | 40.0 | 66.82 | 66.82 | 66.82 |
| PC-1 | 23.2 | 23.2 | 23.2 | 30.4 | 30.4 | 30.4 | 5.72 | 5.72 | 5.72 |
| RDP | 11.1 | 8.1 | 6.1 | 11.0 | 8.0 | 6.0 | 9.03 | 6.03 | 4.03 |
| ABS | 8.3 | 8.3 | 8.3 | 13.0 | 13.0 | 13.0 | 3 | 3 | 3 |
| PCST | 13.3 | 13.3 | 13.3 | 5.0 | 5.0 | 5.0 | 14 | 14 | 14 |
| TSAN | 1.0 | 1.0 | 1.0 | 0.9 | 0.9 | 0.9 | 1 | 1 | 1 |
| PETS | 0.23 | 0.23 | 0.23 | 0.23 | 0.23 | 0.23 | 0.23 | 0.23 | 0.23 |
| Antioxidant (IRGANOX ® 1076) | 0.23 | 0.23 | 0.23 | 0.23 | 0.23 | 0.23 | 0.23 | 0.23 | 0.23 |
| SiC 600R | 0.0 | 11.0 | 13.0 | — | 3.0 | 5.0 | — | 3.0 | 5.0 |
| Talc | 8.0 | — | — | — | — | — | — | — | — |
| Total | 100.0 | 100.2 | 100.1 | 100.8 | 100.8 | 100.8 | 100.0 | 100.0 | 100.0 |
| Thickness for UL-94 V0 rating (mm) | 0.8 | 0.7 | 0.7 | 1.5 | 1 | 1 | 0.76 | 0.7 | 0.7 |
| t₁ + t₂ (sec) (for 5 specimens) | — | 33 | 20 | — | — | 35 | — | 43 | 41 |
| E-modulus (GPa) | 3.2 | 3.15 | 3.28 | 2.75 | 2.83 | 2.86 | — | 2.73 | 2.79 |
| Yield stress (MPa) | 65.0 | 54.0 | 56.0 | 55.6 | 56.9 | 55.7 | — | 58.2 | 57.3 |
| Elongation at Break (%) | 90.0 | 33.0 | 13.0 | 81.0 | 84.5 | 85.5 | 90.0 | 29.0 | 13.6 |
| MAI (J) | 65.0 | 67.4 | 73.4 | 116.1 | 102.1 | 94.5 | — | 93.1 | 87.5 |
| ISO 6602 (3.2 mm Disc) | — | 12.8 | 7.9 | 3.6 | 2.8 | 4.4 | — | 3.5 | 8.9 |
| NII (kJ/m²) | 9.0 | 4.80 | 4.84 | 8.11 | 6.05 | 5.88 | — | 5.53 | 5.28 |
| UNI (kJ/m²) | — | 95.8 | 113.0 | NB | 258.4 | 246.5 | — | 252.8 | 244.0 |
| HDT (° C.) | — | — | — | 76.4 | 86.4 | 92.0 | — | — | — |

As seen in the data in Table 6, the best overall flame retardancy is achieved with the highest loading of SiC filler (Ex. 26) as determined by total flame-out time (t₁+t₂=20 sec). However, a better overall balance of properties is found in Example 27, with higher elongation at break, adequate flame retardancy (V0 at 1 mm) thickness, and both notched and unnotched Izod properties.

Addition of SiC in a blend of polycarbonate and ABS has improved the flammability of the blend at lower thickness (V0@0.7 mm) with the retention of the ductility (Table 6). Addition of SiC has a relatively minimal effect on elongation at break when included at low levels (3-5% by weight; see Examples 27 and 28) where the amount of ABS and low flow PC (PC1) are relatively high, and does not significantly reduce ductility (81% and 85% for Examples 27 and 28, respectively). However, addition of SiC in the same amounts has a more pronounced effect on elongation at break in the presence of relatively low amounts of ABS and PC1 (see Examples 29 and 30) reducing the value for elongation at break to less than 30%. Inclusion of SiC for higher ductility ABS modified compositions is therefore most appropriate for blends having higher proportions of low flow PC.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A thermoplastic composition comprising:
about 49.9 to about 99.9 parts by weight of a polycarbonate polymer,
up to about 50 parts by weight of an impact modifier, and
about 0.1 to about 30 parts by weight silicon carbide particles,
wherein the amounts of the polycarbonate polymer, impact modifier, and silicon carbide are each based on 100 parts by weight of the polycarbonate, silicon carbide particles, and impact modifier,
wherein the thermoplastic composition has a melt volume rate (MVR) of greater than or equal to 5 cc/10 min. when measured at a temperature of 300° C. under a load of 1.2 kg according to ISO 1133, and
wherein an article molded from the thermoplastic composition has a notched Izod impact (NII) of greater than or equal to 4 kJ/m², when measured at a temperature of 23° C. and using a 2.7 J hammer, according to ISO 180.

2. The thermoplastic composition of claim 1, wherein an article molded from the thermoplastic composition has an unnotched Izod impact (UNI) of greater than or equal to about 80 kJ/m², when measured at a temperature of 23° C. and using a 2.7 J hammer, according to ISO 180.

3. The thermoplastic composition of claim 1, wherein the thermoplastic composition has a melt volume rate (MVR) of greater than or equal to 40 cc/10 min. when measured at a temperature of 300° C. under a load of 5 kg according to ISO 1133.

4. The thermoplastic composition of claim 1, wherein the thermoplastic composition has a melt volume rate (MVR) of greater than or equal to 12 cc/30 sec., when measured at a temperature of 300° C. under a load of 2.16 kg according to ISO 1133.

5. The thermoplastic composition of claim 1, wherein the thermoplastic composition comprises polycarbonates comprising homopolycarbonates, copolycarbonates, polyester-polycarbonates, polysiloxane-polycarbonates, or a combination comprising at least one of the foregoing polycarbonates.

6. The thermoplastic composition of claim 1, wherein the polycarbonate is bisphenol A polycarbonate homopolymer.

7. The thermoplastic composition of claim 1, wherein the silicon carbide particles have an average particle size of greater than 0.2 μm to 1,000 μm.

8. The thermoplastic composition of claim 1, wherein the silicon carbide particles have an average particle size of greater than 1 nm to 200 nm.

9. The thermoplastic composition of claim 1, wherein the silicon carbide particles are treated.

10. The thermoplastic composition of claim 1 having a V0 flammability rating when molded into an article having a thickness of less than or equal to 1.6 mm, when tested according to UL 94.

11. The thermoplastic composition of claim 1, wherein the impact modifier comprises an elastomer-modified graft polymer selected from the group consisting of poly(acrylonitrile-butadiene-styrene), poly(acrylonitrile-styrene-butyl acrylate), poly(methyl methacrylate-butadiene-styrene), poly(methyl methacrylate-acrylonitrile-butadiene-styrene), poly(acrylonitrile-ethylene-propylene-diene-styrene), and combinations thereof.

12. The thermoplastic composition of claim 11, wherein the elastomer-modified graft polymer comprises poly(acrylonitrile-butadiene-styrene).

13. The thermoplastic composition of claim 11, wherein the impact modifier composition comprises an elastomer-modified graft polymer and a rigid thermoplastic polymer that is not a polycarbonate.

14. The thermoplastic composition of claim 13, wherein the rigid thermoplastic polymer is selected from the group consisting of poly(styrene-acrylonitrile), poly(styrene-alpha-methyl styrene-acrylonitrile), poly(methyl methacrylate-acrylonitrile-styrene), poly(methyl methacrylate-styrene), and mixtures thereof.

15. The thermoplastic composition of claim 13, wherein the elastomer-modified graft polymer comprises poly(acrylonitrile-butadiene-styrene), and wherein the rigid thermoplastic polymer comprises poly(styrene-acrylonitrile).

16. The thermoplastic composition of claim 1, further comprising an additive including filler, antioxidant, heat stabilizer, light stabilizer, ultraviolet light absorber, plasticizer, mold release agent, lubricant, antistatic agent, flame retardant, anti-drip agent, gamma stabilizer, or a combination comprising at least one of the foregoing additives, where the additive is present in amount that does not significantly adversely affect the desired properties of the thermoplastic composition.

17. A thermoplastic composition comprising:
about 49.9 to about 94.9 parts by weight of a polycarbonate polymer having a melt volume rate (MVR) of 0.5 to 20 cc/10 min, measured at 300° C. under a load of 1.2 kg according to ISO 1133,
about 0.1 to about 50 parts by weight of an impact modifier, and
about 5 to about 15 parts by weight silicon carbide particles,
wherein the amounts of the polycarbonate polymer, impact modifier, and silicon carbide are each based on 100 parts by weight of the polycarbonate, silicon carbide particles, and impact modifier,
wherein an article molded from the thermoplastic composition has a notched Izod impact (NII) of greater than or equal to about 4 kJ/m², when measured at a temperature of 23° C. and using a 2.7 J hammer, according to ISO 180, and
wherein an article molded from the thermoplastic composition has an unnotched Izod impact (UNI) of greater than or equal to about 80 kJ/m², when measured at a temperature of 23° C. and using a 2.7 J hammer, according to ISO 180.

18. A method of forming a thermoplastic composition, comprising melt blending:
about 49.9 to about 99.9 parts by weight of a polycarbonate polymer,
up to about 50 parts by weight of an impact modifier, and
about 0.1 to about 30 parts by weight silicon carbide particles,
wherein the amounts of the polycarbonate polymer, impact modifier, and silicon carbide are each based on 100 parts by weight of the polycarbonate, silicon carbide particles, and impact modifier,
wherein the thermoplastic composition has a melt volume rate (MVR) of greater than or equal to about 5 cc/10 min. when measured at a temperature of 300° C. under a load of 1.2 kg according to ISO 1133,
wherein an article molded from the thermoplastic composition has a notched Izod impact (NII) of greater than or equal to about 4 kJ/m², when measured at a temperature of 23° C. and using a 2.7 J hammer, according to ISO 180.

19. A thermoplastic composition prepared by the method of claim 18.

20. An article comprising the thermoplastic composition of claim 1.
